(19) United States
(12) Patent Application Publication
(10) Pub. No.: US 2025/0209356 A1
(43) Pub. Date: Jun. 26, 2025

(54) QUANTUM CIRCUITS FOR A NEUTRAL ATOM QUANTUM PROCESSOR

(71) Applicant: PASQAL S.A.S., Massy (FR)

(72) Inventors: Vincent Emanuel Elfving, Amsterdam (NL); Louis-Paul Henry, Massy (FR); Loïc Henriet, Massy (FR)

(21) Appl. No.: 18/847,552

(22) PCT Filed: Mar. 20, 2023
(86) PCT No.: PCT/EP2023/057093

§ 371 Date: Sep. 16, 2024

(30) Foreign Application Priority Data
Mar. 19, 2022 (FR) FR2202443

(51) Int. Cl. G06N 10/20; G06N 10/40; G06N 10/60

(52) U.S. Cl. CPC G06N 10/20; G06N 10/40; G06N 10/60

(57) ABSTRACT

A data processing system comprising a classical computer connected to neutral atom quantum processor implement a method comprising encoding at least part of a computational problem in quantum circuit(s) comprising gate operations to be executed by the neutral atom quantum processor. A first quantum circuit comprises a feature map configured to map an input variable of a solution to a Hilbert space associated with the neutral atom quantum processor and parameterized ansatz(s). Digital quantum gate operations and analog quantum gate operation(s) are configured to entangle different neutral atoms evolving a Hamiltonian associated with the neutral atoms in time. The classical computer system applies optical signals to the neutral atoms of the quantum processor to manipulate the states of the atoms, the execution providing a final state of the neutral atom quantum computer Measurement data associated with the final state of the neutral atoms is used to determine an approximate.

### CROSS-REFERENCE TO RELATED APPLICATION(S)

This Application is a Section 371 National Stage Application of International Application No. PCT/EP2023/057093, filed Mar. 20, 2023 and published as WO 2023/180254 A1 on Sep. 28, 2023, in English, and further claims priority to French Application Number 2202443, filed Mar. 19, 2022.

### TECHNICAL FIELD

The disclosure relates to quantum circuits for a neutral atom quantum processor and, in particular, though not exclusively, to methods and systems for executing quantum circuits, in particular digital-analog quantum circuits, on a neutral atom quantum processor, to method and systems for solving a problem using such quantum circuits and a computer program product enabling a data processing system comprising a neutral atom quantum processor to execute such methods.

### BACKGROUND

Quantum computers or quantum processing units QPUs change the way information is processed. For certain problems they offer drastic computational speed up, ranging from quadratic acceleration of searching unstructured data, to exponential improvements for factoring large numbers used in encryption applications. Using qubits and coherent superpositions of binary strings, QPUs utilize quantum interference effects to amplify the correct solution, reached in fewer steps than classical computers ever can. QPU-based computers are well-suited for chemistry applications, as they are naturally suitable for the simulation of certain quantum processes. At the same time, QPU-based computers are not directly suited for all computational problems, and can be seen as specialized machines (akin to GPUs), that need to be tailored to the problem at hand. Designing these machines and their operational schedule is crucial for solving problems faster than any available classical methods. This remains true for tasks and applications in differential calculus.

While much progress has been made in recent years, implementing quantum machine learning algorithms, such as differentiable quantum circuits (DQC), on a QPU to solve complex problems such as differential equations, remains a huge challenge. In particular, a quantum advantage in solving such problems has not been achieved yet, while the number of qubits is already sufficient. The main reason is that the currently most popular computational paradigm, digital gate-based universal quantum computation, faces huge challenges in achieving sufficient fidelities and low-enough noise rates. It is very challenging to perform sufficiently deep digital circuits to reach the entanglement levels that are needed for achieving an advantage over classical methods, because each gate has a limited associated fidelity and the total fidelity is exponentially suppressed in the number of such gates. Quantum circuit differentiation is necessary for representing function derivatives in quantum circuit, and for analytical gradient descent in quantum machine learning in general. Circuit differentiation is costly and scales with the number of distinct gates where parameters appear, and typically N of them are used where N are the number of qubits. This can be problematic for larger numbers of qubits.

One particularly promising candidate for scalable QPUs is the neutral atom QPU. A description of such neutral atom quantum processor is described in the article by Loic et al, Quantum Computing with neutral atoms, Quantum 4, 327 (2020), which is hereby incorporated by reference. This platforms in principle offers the potential for scaling the number of qubits far beyond what is available today, from tens of qubits to hundreds or thousands of qubits. The article describes two distinct and well-known modes of operation of the neutral atom QPU namely digital quantum computing and analog quantum computing. In digital quantum computation a predetermined number of individual gate operations described in a quantum circuit are individually executed in time for different qubits of the QPU. This scheme is somewhat similar to a classical computer wherein the CPU executes digital operations of a program. Many digital quantum computation schemes have been developed for solving complex problems such as solving nonlinear differential equations.

In contrast, analog quantum processing refers to a scheme where qubits are mapped on a spin Hamiltonian which is then evolved over time towards its ground state. Analog quantum processing is a well-known scheme for simulating quantum systems, such as materials in condensed matter problems, but less suitable for problems such as solving differential equations or the like. Hence, to access the full potential of quantum computing of the neutral atom quantum computer, it should be capable of executing complex digital quantum circuits with high fidelity. This however poses a challenge as optically addressing individual atoms or small clusters of atoms sequentially and/or in parallel in a neutral quantum register comprising many atoms is currently a non-trivial problem. It is therefore not straightforward to compile and execute a large number of digital gates, in particular a large number of two-gate or multi-gate operations, on a neutral atom QPU, thus limiting the use of many algorithms which originally were designed as digital-gates algorithms having conventional superconducting or solid state (e.g. quantum dot) qubits in mind.

Hence, from the above, it follows that there is therefore a need in the art for improved quantum circuits that are especially suitable for execution by a neutral atom quantum processor and allow implementation and execution of advanced quantum algorithms, such as complex differential equations, on a neutral atom quantum processor.

### SUMMARY

As will be appreciated by one skilled in the art, aspects of the present embodiments may be embodied as a system, method or computer program product.

Accordingly, aspects of the present embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present embodiments may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present embodiments may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

A substantial part of the embodiments in this application includes or relies on constructs referred to as ‘quantum circuits’. Quantum circuits are depicted as schematic diagrams, typically read from left to right, involving one or more ‘qubits’ evolving in time under the influence of a set of operations called ‘gates’, until at the end a measurement is performed on the one or more qubits. These qubits are depicted as lines, and blocks overlapping these lines are to be interpreted as involving those qubits in their operation. These gate operations can therefore be considered either “single-qubit gates” or “multi-qubit gates”, when they involve with one or more qubits respectively.

Gate operations can furthermore fall into two (overlapping) categories, ‘digital’ gate operations or ‘analog’ gate operations. In an abstract sense, these definitions are not strictly distinct. To be more precise, analog gates refer to all unitary operations which result from evolution of the one or more involved qubits over some controllable Hamiltonian. Here, a controllable Hamiltonian means the terms in the Hamiltonian can be tuned up or down in time. In the case of neutral atom quantum computing, the Hamiltonian is controlled by parameters such as laser light amplitude, phase, detuning, and interatomic distances. Importantly, it may not always be possible to classically compute the effect this analog block has on the qubit register state. Here, reference is made to “not always possible” because in general the Hamiltonian is not fast-forwardable, i.e. it contains non-commuting terms. However, it is a deterministic operation and has distinct effects given distinct Hamiltonian parameter (schedule)s.

A subclass of such operations can be considered as what is referred to as digital operations. Digital operations are in essence calibrated, simple and often small analog operations. Taking the example of a single qubit digital gate, the three rotation gates Rx, Ry, Rz can be considered which are generated by propagating the single qubit by the single-qubit Hamiltonians X, Y, or Z respectively over a time theta at constant amplitude, or more generally such that the area under the pulse sequence is equal to theta. This means an operation is performed in such a way, that its effect on the qubit is indiscernible from a prototypical constant-amplitude. Therefore, a user/programmer of the quantum computer can instruct the quantum computer to perform a “pi/3 rotation on qubit 1”, which is a digital gate description. This is translated by a low-level compiler to a laser pulse sequence, which evolves the state over the desired axis, and which has a total area under the pulse equal to pi/3. This concept of compiled or programmed digital gates can be extended to larger, multi-qubit gates such as CNOT or CZ gates, which involve more than one qubit but still perform a clearly pre-defined operation. The low-level hardware implementation may differ substantially between different architectures, but in the logical space of qubits the effect is the same.

It has been proven that any computation can be decomposed into a finite set of digital gates, including always at least one multi-qubit digital gate (universality of digital gate sets). This includes being able to simulate general analog Hamiltonian evolutions, by using Trotterization or other simulation methods. However, the cost of Trotterization is expensive, and decomposing multi-qubit Hamiltonian evolution into digital gates is costly in terms of number of operations needed.

In this application, reference is made to the term ‘digital-analog’ which define circuits which are decomposed into both explicitly-digital and explicitly-analog operations. While under the hood, both are implemented as evolutions over controlled system Hamiltonians, the digital gate operations form a small set of pre-compiled operations, typically but not exclusively on single-qubits, while analog operations are used to evolve the system over its natural Hamiltonian, for example in order to achieve complex entangling dynamics.

It can be shown that complex multi-qubit analog operations can be reproduced/simulated only with a relatively large number of digital gates, thus posing an advantage for devices that achieve good control of both digital and analog operations. Entanglement can spread more quickly in terms of wall-clock runtime of a single analog block compared to a sequence of digital gates, especially when also considering the finite connectivity of purely digital devices.

In an aspect, the embodiments in this application relate to a method for solving a computational problem using a data processing system comprising a classical computer connected to neutral atom quantum processor. The method may include encoding at least part of the computational problem in one or more digital-analog quantum circuits, comprising one or more digital quantum gate operations, operating on individual neutral atoms, and one or more analog quantum gate operations operating on a plurality of neutral atoms of the neutral atom quantum computer for entangling the plurality of neutral atoms by evolving a Hamiltonian associated with the neutral atoms in time; executing the one or more quantum circuits, the executing including applying pulse signals to the neutral atoms of the quantum processor to manipulate the states of the atoms in accordance with the one or more digital and analog quantum operations, the execution providing a final state of the neutral atom quantum processor; and, determining measurement data associated with the final state of the neutral atoms; and, determining an approximate solution for the computational problem based on the measurement data.

In another aspect, the embodiments in this application relate to a method for solving a computational problem using a data processing system comprising a classical computer connected to neutral atom quantum processor. In an embodiment, the method may include encoding at least part of the computational problem in one or more quantum circuits, the one or more quantum circuits comprising a first quantum circuit comprising at least one feature map configured to map an input variable of a solution of the computational problem to a Hilbert space associated with the neutral atom quantum processor and at least one parameterized ansatz, the at least one first quantum circuit further including digital quantum gate operations and one or more analog quantum gate operations configured to entangle a plurality of neutral atoms of the neutral atom quantum computer by evolving a Hamiltonian associated with the neutral atoms in time; executing the one or more quantum circuits, the executing including applying optical signals to the neutral atoms of the quantum processor to manipulate the states of the atoms in accordance with the one or more quantum circuit, the execution providing a final state of the neutral atom quantum computer; and, determining measurement data associated with the final state of the neutral atoms; and, determining an approximate solution for the computational problem based on the measurement data.

In an embodiment, the one or more quantum circuits comprising gate operations to be executed by the neutral atom quantum processor

In an embodiment, the one or more digital quantum gate operations comprise one or more single digital quantum gate operations.

Thus, instead of executing a quantum circuit block comprising a plurality of complex two of multi-qubit digital gate operations, an analog gate operation is executed when an entanglement operation involving a plurality (two or more) of qubits is needed. This way, the problem of individually addressing multiple atoms in the register to achieve complex digital two- and multi-qubit operations can be avoided, and quantum circuits can be efficiently executed on a neutral atom computer as a set of single gate operations and one or more analog gate operations. Hence, the embodiments relate to implementing a digital-analog (DA) operational mode for evaluating quantum circuits on a neutral atom (NA) quantum processor with the benefit of getting enhanced fidelity, more rapid spread of entanglement on a neutral atom quantum processor, allowing near-term implementations of advance problem computation schemes. The advantageous digital analog circuits may include any configuration of single- or multi-qubit, digital or analog, serial or parallel, sequential or simultaneous gate operations.

The neutral atom quantum processor may use any atom that exhibits Rydberg physics including but not limited to rubidium and strontium atoms.

In an embodiment, the quantum feature map and/or the parameterized ansatz comprises at least one analog quantum gate operation.

In an embodiment, the one or more quantum circuits may comprise a second quantum circuit, the second quantum circuit representing an analytical derivative of the first quantum circuit.

In an embodiment, the second quantum circuit may comprise a differentiated quantum feature map, wherein the differentiated quantum feature map is obtained by differentiating the quantum feature map with respect to the input variable. In an embodiment, the feature map is analytically differentiated with respect to the input variable.

In an embodiment, the second quantum circuit may include a differentiated parameterized ansatz, wherein the differentiated quantum feature map is obtained by differentiating the parameterized ansatz with respect to a parameter associated with the parameterized ansatz. In an embodiment, the parameterized ansatz is analytically differentiated with respect to a parameter associated with the parameterized ansatz.

The inventors found that digital-analog quantum circuits for neutral atom quantum processors are differentiable. Hence, variational ansatze, parameterized by variational parameters, that may comprise one or more analog blocks can be differentiated analytically. This may be important for gradient-descent purposes. Similarly, quantum feature maps can be constructed based on one or more analog blocks with evolution times proportional to the input variable, and can be differentiated analytically with respect to the feature variables. This way, the digital-analog quantum circuits can be used to implement DQC schemes and quantum machine learning schemes that require differentiable quantum circuits on a neutral atom computer.

In an embodiment, the digital gate operations and the analog gate operations may be based on a first and second energy levels of the atom. In an embodiment, the first energy level being associated with the ground state or a hyper-fine energy level of the atoms and the second energy level being associated with the Rydberg state of the atoms.

In an embodiment, the digital gate operations and the analog gate operations may be based on a first, second and third energy level of the atoms, wherein the digital gate operations are based on the first and second energy level and the analog gate operations are based on the second and third energy level. In an embodiment, the first energy level may be associated with a ground state of the atoms, a second energy level being associated with a hyper-fine energy level of the atoms and a third energy level associated with the Rydberg state of the atoms.

In an embodiment, the Hamiltonian may include a first part representing an interaction of states of a neutral atom of the neutral atom processor and a laser field, preferably the amplitude and the frequency of the laser field, and a second part representing an interaction between different neutral atoms if the neutral atoms are in a Rydberg state.

In an embodiment, the Hamiltonian may be a Rydberg Hamiltonian.

In an embodiment, the method may include controlling the position of the atoms of the neutral atom quantum processor such that the atoms form a predetermined spatial arrangement, preferably the predetermined spatial arrangement including a dimensional (1D), two-dimensional (2D) or three-dimensional (3D) grid,

In an embodiment, the distance between neighboring atoms in the predetermined spatial arrangement may be selected such that if neighboring atoms are not in a Rydberg state, there is no interaction between neighboring atoms, and if the neighboring atoms are in a Rydberg state, there is an interaction between these neighboring atoms.

In an embodiment, the one or more quantum circuits may include instructions for controlling the position of the atoms during the execution of the one or more quantum circuits and wherein executing the one or more quantum circuits include: changing positions of atoms in the predetermined spatial arrangement to allow an atom to have different neighboring atoms during the execution of the one or more quantum circuits.

In an embodiment, executing the one or more quantum circuit may further include translating the one or more quantum circuits into optical signals for controlling the states of the neural atoms in accordance with the gate operations of the quantum circuit and for readout of a final state of the neutral atoms.

In an embodiment, executing the one or more quantum circuits may include translating a first digital gate operation and a second digital gate operation into control information for exposing a first atom with a first optical pulse and a second atom with a second optical pulse, wherein the first and second pulses have a predetermined amplitude, frequency and duration to control the states of the first and second atom in accordance with the first and second digital gate operations respectively; and, using the control information to control one or more light sources and one or more optical deflectors or one or more spatial light modulators to locally expose the first and second atom with the first and second optical pulse.

In an embodiment, executing the one or more quantum circuits includes optically addressing one or more individual neutral atoms in accordance with the one or more digital quantum gate operations.

In an embodiment, executing the one or more quantum circuits includes optically addressing the plurality of neutral atoms in accordance with the one or more analog quantum gate operations.

In an embodiment, one or more micromirrors may be used to optically address the individual neutral atoms associated with the one or more digital quantum gate operations and the plurality of neutral atoms associated with the one or more analog quantum gate operations.

In a further aspect, the embodiments may relate to a system for solving a computational problem comprising a classical computer connected to neutral atom quantum processor, wherein the system may be configured to perform the steps of: encoding at least part of the computational problem in one or more quantum circuits, the one or more quantum circuits comprising gate operations to be executed by the neutral atom quantum processor, the one or more quantum circuit comprising a first quantum circuit comprising at least one feature map configured to map an input variable of a solution of the computational problem to a Hilbert space associated with the neutral atom quantum processor and at least one parameterized ansatz, the at least one first quantum circuit further including digital quantum gate operations, preferably digital single quantum gate operations, and one or more analog quantum gate operations configured to entangle different neutral atoms of the neutral atom quantum computer evolving a Hamiltonian associated with the neutral atoms in time; executing the one or more quantum circuits, by the classical computer system, the executing including applying optical signals to the neutral atoms of the quantum processor to manipulate the states of the atoms in accordance with the one or more quantum circuit, the execution providing a final state of the neutral atom quantum computer; and, determining measurement data associated with the final state of the neutral atoms; and, determining an approximate solution for the computational problem based on the measurement data.

In further embodiment, the system may be configured to perform any of the method steps as described above.

The embodiments may further relate to a computer program or suite of computer programs comprising at least one software code portion or a computer program product storing at least one software code portion, the software code portion, when run on a classical computer system wherein the classical computer is part of a data processing system comprising the classical computer system connected to a neutral atom quantum processor, being configured for executing the method steps according any the embodiments described above.

The digital-analog quantum circuits for the neural atom quantum processor as described with reference to the embodiments in this application can be applied to any scheme that requires differentiable quantum circuits which includes not only DQC for solving differential equations but also derivative work of DQC, including but not limited to Quantum Quantile Mechanics (QQM), Quantum Model Discovery (QMOD), Differentiable Quantum Generative Modelling (DQGM) and Quantum Kernel methods for differential equations.

The embodiments will be further illustrated with reference to the attached drawings, which schematically will show embodiments. It will be understood that the invention is not in any way restricted to these specific embodiments.

### BRIEF DESCRIPTION OF THE DRAWINGS

FIGS. 1A and 1B depict a network of data processing system and an optimization scheme for solving nonlinear DEs according to an embodiment;

FIGS. 2A and 2B depicts differentiable quantum circuits DQC according to various embodiments;

FIG. 3A-3C depict quantum circuits according to various embodiments;

FIGS. 4A and 4B illustrate exemplary variational quantum circuits according to various embodiments;

FIG. 5 schematically depicts a flow diagram of a method for solving (non-) linear DEs using quantum computation according to an embodiment;

FIG. 6A-6B depict a method for solving general (non-) linear DEs using quantum computation according to an embodiment;

FIG. 7 is a hardware-level schematic illustrating the application of logical operations to qubits using a quantum circuit;

FIGS. 8A and 8B depict an example of a neutral atom quantum computer;

FIG. 9 depicts the representation of a quantum state of a neutral atom on a Bloch sphere;

FIG. 10A-10D depict implementations of quantum spin models with neutral atoms;

FIGS. 11A and 11B illustrate a scheme for executing single qubit operations on a neutral atom processor;

FIG. 12 depicts illustrate a further scheme for executing single qubit operations on a neutral atom processor;

FIG. 13A-13C show a quantum circuit for a neutral atom quantum processor according to an embodiment;

FIGS. 14A and 14B show pulse diagrams for executing digital-analog quantum circuits on a neutral atom qubit register according to an embodiment;

FIG. 15 shows a graph representing the solution of a differential equation that has been solved using differentiable digital-analog quantum circuits according to an embodiment;

FIGS. 16A and 16B illustrate an example of quantum circuit for of a neutral atom quantum computer according to another embodiment;

FIG. 17 illustrates an example of quantum circuit for of a neutral atom quantum computer according to yet another embodiment;

FIG. 18 illustrates an example of quantum circuit for of a neutral atom quantum computer according to a further embodiment;

FIG. 19 illustrates a system for optically addressing qubits of a qubit array according to an embodiment.

### DESCRIPTION OF THE EMBODIMENTS

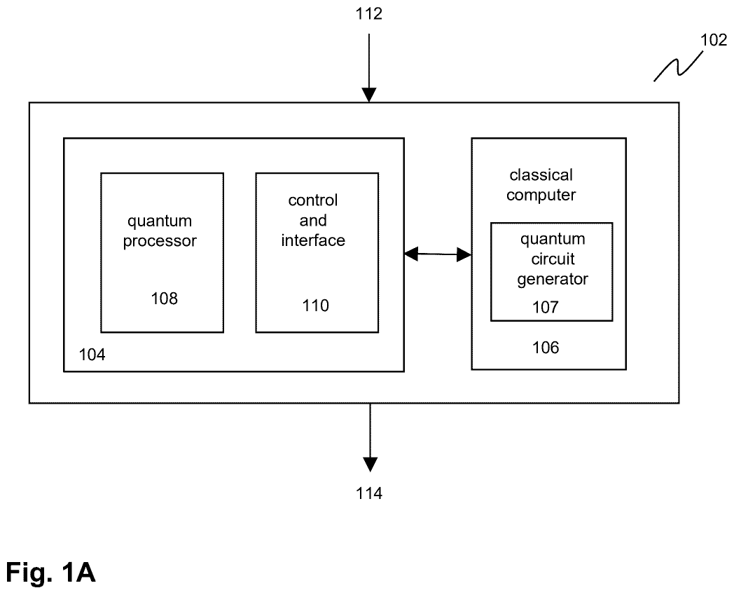

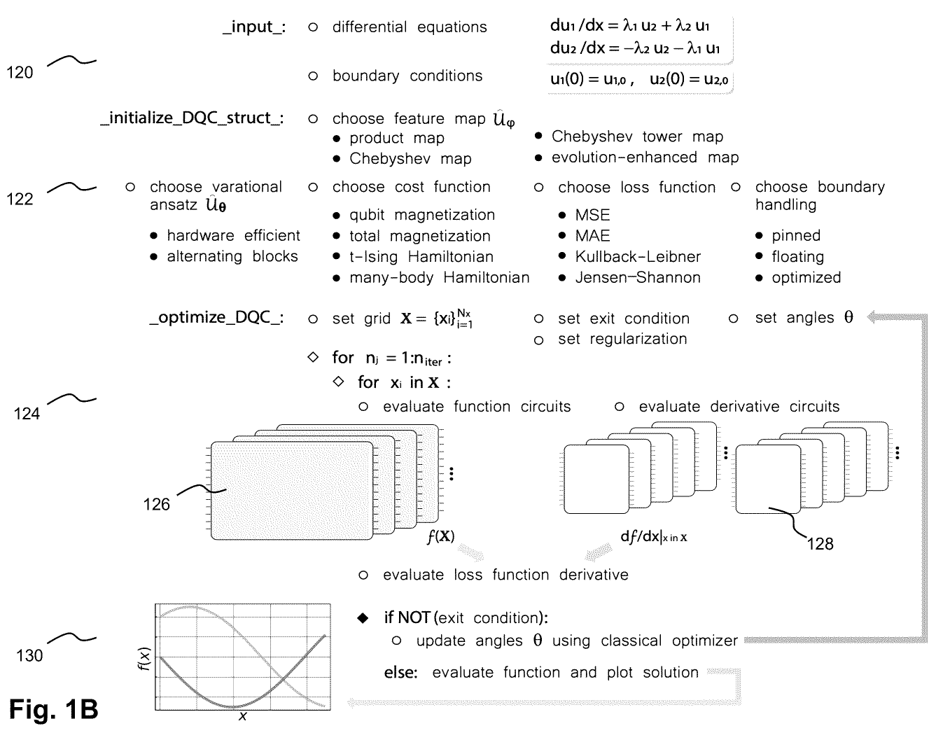

FIGS. 1A and 1B depict a data processing system and an optimization scheme for solving nonlinear differential equations according to an embodiment. In particular, FIG. 1A depicts a system 102 including a first data processing system connected to a second data processing system 106, wherein the first data processor system may be implemented as a quantum computer system 104 comprising a quantum processor system 108, comprising quantum processing elements e.g. gate-based qubits, and a controller system 110 comprising input output (I/O) devices which form an interface between the quantum processor and a second data processor, e.g. a classical computer 106 comprising one or more classical processors. The controller system may include a system for generating control signals for controlling the quantum processing elements. The control signals may include for example a sequence of pulses, e.g. microwave pulses, voltage pulses and/or optical pulses, which are used to manipulate qubits. Further, the controller may include output device, e.g. readout circuits, for readout of the qubits and the control signals for readout of the quantum processing elements, e.g. a readout pulse for reading a qubit. In some embodiments, at least a part such readout circuit may be located or integrated with the chip that includes the qubits.

The system may further comprise a (purely classical information) input 112 and an (purely classical information) output 114. The data processor systems may be configured to solve nonlinear differential equations using the quantum computer. Input data may include information related to the differential problem to be solved. This information may include the differential equations, boundary conditions, information for construction quantum circuits that can be executed on the quantum computer and information about an optimization process that needs to be executed to compute the solutions to the nonlinear differential equations. The input data may be used by the system to construct quantum circuits, for example digital-analog quantum circuits and/or differentiable quantum circuits as described with reference to the embodiments in this application. The input data may also be used to classically determine parameters and control signals, e.g. sequences of pulses, which may be used to initialize and control qubit operations according to the quantum circuit. To that end, the classical computer may include a quantum circuit generator 107 configured to encode at least part of a computational problem into a quantum circuit comprising quantum gate operations that can be executed by the quantum processor. Output data may include ground state and/or excited state energies of the quantum system, correlator operator expectation values, optimization convergence results, optimized quantum circuit parameters and hyperparameters, and other classical data.

Each of the one or more quantum processors may comprise a set of controllable quantum processing elements, e.g. a set of controllable two-level systems referred to as qubits. The two levels are |0 [symbol] and |1 [symbol] and the wave function of a N-qubit quantum processor may be regarded as a superposition of 2^{N} of these basis states. The embodiments in this application however are not limited to qubits but may include any multi-level quantum processing elements, e.g. qutrits, that is suitable for performing quantum computation Examples of such quantum processors include noisy intermediate-scale quantum (NISQ) computing devices and fault tolerant quantum computing (FTQC) devices.

The quantum processor may be configured to execute a quantum algorithm in accordance with the gate operations of a quantum circuit. The quantum processor may be implemented as a gate-based qubit quantum device, which allows initialization of the qubits into an initial state, interactions between the qubits by sequentially applying quantum gates between different qubits and subsequent measurement of the qubits' states. To that end, the input devices may be configured to configure the quantum processor in an initial state and to control gates that realize interactions between the qubits. Similarly, the output devices may include readout circuitry for readout of the qubits which may be used to determine a measure of the energy associated with the expectation value of the Hamiltonian of the system taken over the prepared state.

In some embodiments, the first data processor system may be implemented as a software program for simulating a quantum computer system 104 comprising a quantum processor system 108. Hence, in that case, the software program may be a classical software program that runs a classical computer 106 so that quantum algorithms can be developed, executed and tested on a classical computer without requiring access to a hardware implementation of the quantum processor system.

Some of embodiments in this application aim to solve computational problems, such as nonlinear differential equations of a general form using a quantum computer, in a way that is substantially different from the schemes known in the prior art. For a given set of nonlinear differential equations, quantum circuits may be constructed based on so-called differentiable quantum circuits (DQCs). These quantum circuits may be executed on the quantum computer and a cost function, e.g. an Hermitian operator such as a Hamiltonian, may be used to measured observables that form an approximation of the solution to the set of nonlinear differential equations are used in a classical optimization algorithm. A loss function may be used to determine if the approximation of the solution is sufficiently close to the solution to the set of nonlinear differential equations.

An exemplary workflow of the optimization loop is provided in FIG. 1B, showing an input step 120 for receiving information about the differential problem, e.g. a set of differential equations and boundary conditions. Thereafter, an optimization scheme may be initialized 122, wherein a quantum circuit may be constructed based on differentiable quantum circuits, wherein quantum circuits may represent a function and derivative functions circuits. The construction of the quantum circuit may include selection of a quantum feature map circuits, a variational ansatz circuits which can be adjusted by an optimization parameter θ, a cost function and a loss function that can be used to exit the optimization loop.

Thereafter, the optimization scheme may be started by determining approximate solutions for the set of differential equations at a set of points xⱼ. To that end, for each point xⱼ the quantum circuit is executed on the quantum computer. As shown in the figure, the quantum circuit may include function circuits 126 and derivative function circuits 128. A function circuit may be used to evaluate a function ƒ around point xⱼ and a derivative function circuit may be used to evaluate the derivative of the function dƒ/dx around point xⱼ. The execution of each quantum circuit will result in a measured value, an observable of the quantum state of the quantum computer, representing an approximation of a function value or a derivative value at a particular point xⱼ. Then, the loss function and the measured values may be used to determine if the measured values form a sufficient accurate approximation of the solution to the set of differential equations. If this is not the case, in a further step 130, a classical optimization scheme may be used to update the optimization parameter θ of the variational ansatz circuit. Thereafter, approximate solutions are determined for each xⱼ by executing the quantum circuits based on updated the optimization parameter θ.

It is submitted that the differential equations described with reference to the scheme of FIG. 1B only illustrate a few examples of the many different types of differential equations that can be solved on the basis of this scheme. Examples of such differential equations can be found throughout this application and may include parameterized differential equations. For example, in an embodiment, a parameterized differential equation may comprise one or more of the elements in the equation which are (hyper) parameters (alpha/beta) rather than functions (ƒ(x), g(x,y)) or dependent/dimensional variables (x, y, z, t).

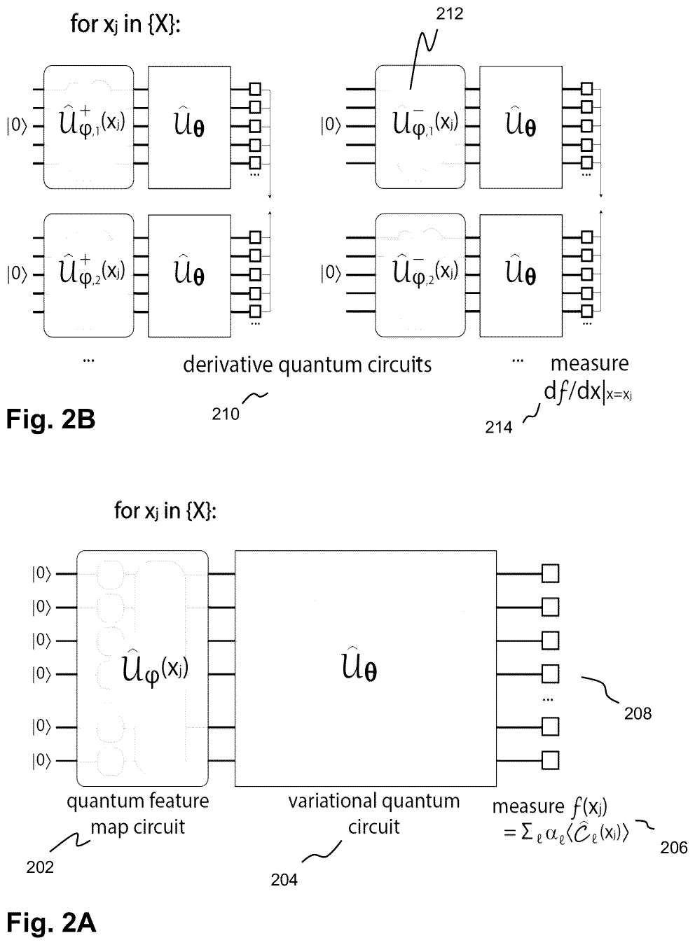

FIGS. 2A and 2B depicts differentiable quantum circuits according to various embodiments. In particular, the circuit in FIG. 2A comprises feature map circuit 202, a variational quantum circuit 204 followed by a readout 208. A quantum feature map is configured to encode data in a quantum register, e.g. a classical variable x is transformed into a set of phases of rotations. The quantum feature map circuit actuates a unitary evolution Û_{φ} over the qubits of the quantum computer, wherein the unitary evolution is a function of differential equation parameter x, as well as variational ansatz Û_{θ} 204, and an observable-based readout 208 for the set of operators [symbol] comprising the cost function Hamiltonian: ƒ(xⱼ)= [symbol] . Combining measurements 206, a trial function ƒ(xⱼ) may be computed as a potential solution to the differential equation.

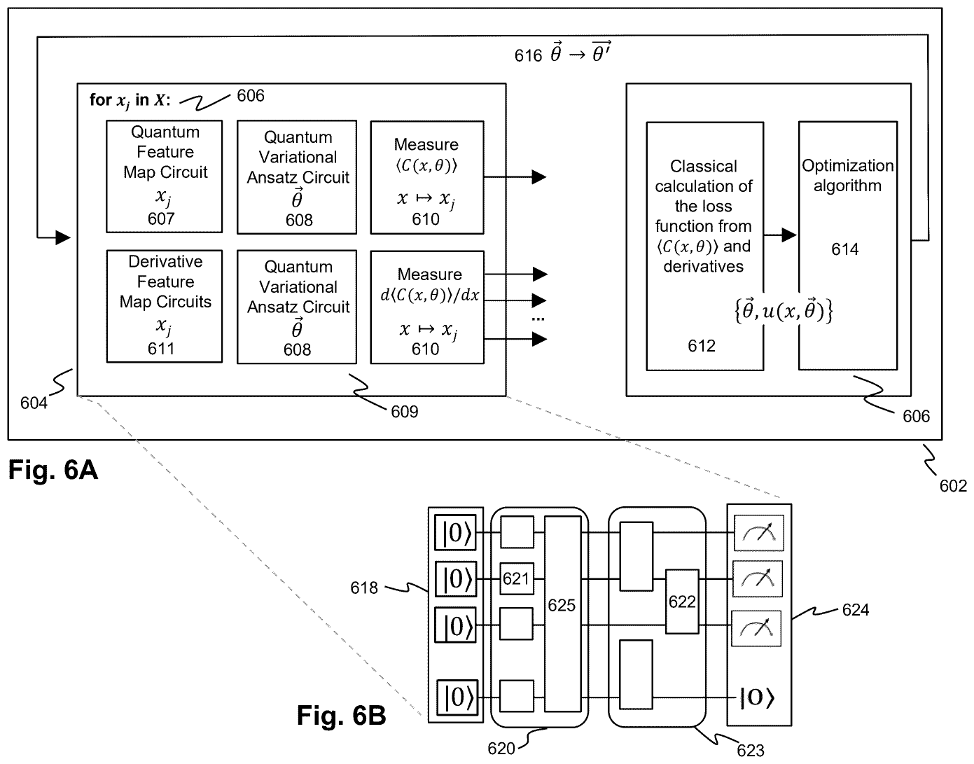

Thus, the quantum circuit used for encoding the value of the function at specific value of the variable x=xⱼ, comprises a feature map Û_{φ} that encodes the x-dependence into the quantum computer, followed by variational ansatz Û_{θ}, and observable-based readout for the set of operators [symbol] . The measurement result is classically post-processed to provide a quantum function representation ƒ(x) as a sum of expectations, where coefficients αₗ, can be optimized in a quantum-classical hybrid loop as e.g. described with reference to FIGS. 6A and 6B. To compose the loss function circuit, measurements for different points of optimization grid {X} are required.

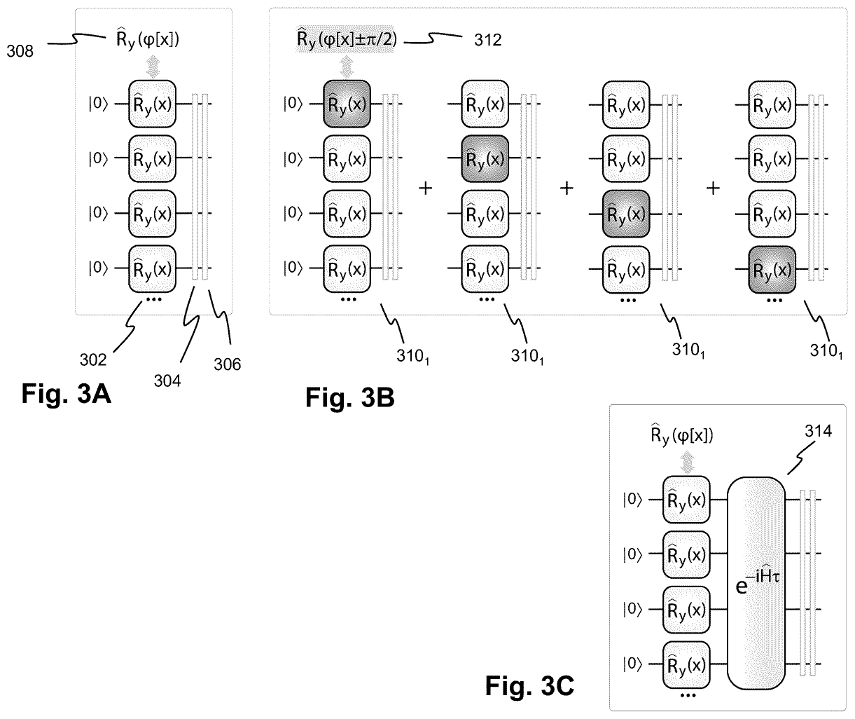

FIG. 2B depicts a similar structure as illustrated in FIG. 2A, but instead is used to compute the derivative of the function ƒ with respect to x 214, using derivative quantum circuits 210, and evaluated at x=xⱼ. A particular difference with the circuits depicted in FIG. 2A is the parametric shift of variables in unitary 212. The derivative of the sought function ƒ(x) evaluated at specific point x=xⱼ may be estimated as a sum of expectations for derivative quantum circuits. The full structure follows from the differentiation of the feature map circuit as e.g. described with reference to FIG. 3. The measurement results of the function and derivate measurements may be classically post-processed, and combined for all j in xⱼ from x. Further, variational coefficients θ and cost structure coefficients α may be optimized in a quantum-classical hybrid loop in order to reduce the loss function value for θ and α settings as described with reference to FIG. 6.

Thus, as can be seen from FIG. 2, trial functions may be prepared as quantum circuits parametrized by variables x ∈ [symbol] (or a collection of variables) of the differential equations as shown in FIG. 2. As the discussion is generalized straightforwardly to the case of v variables, x∈ [symbol] ^{v}, for brevity the simplified single variable notation x is used. Using quantum feature map encoding Û_{φ}(x), a pre-defined nonlinear function of variables φ(x) is cast to amplitudes of the quantum state Û_{φ}(x)|∅ [symbol] prepared from some initial state |∅ [symbol] . Using quantum feature map encoding Û_{φ}(x), a pre-defined nonlinear function of variables φ(x) is cast to amplitudes of the quantum state Û_{φ}(x)|∅ [symbol] prepared from some initial state |∅ [symbol] .

A quantum feature map represents a latent space encoding, that unlike amplitude encoding, does not require access to each amplitude and is controlled by classical gate parameters. The quantum feature maps real parameter x to the corresponding variable value. Next, a variational quantum circuit Û_{θ} parametrized by vector θ that can be adjusted in a quantum-classical optimization loop is used. The resulting state |ƒ_{φ,θ}(x) [symbol] =Û_{θ}Û_{φ}(x)|∅ [symbol] for optimal angles contains the x-dependent amplitudes sculptured to represent the sought function. Finally, the real valued function can be read out as an expectation value of predefined Hermitian cost operator Ĉ, such that the function reads:

$$f ( x ) = 〈 {f}_{φ , θ} ( x ) \vert \hat{C} \vert {f}_{φ , θ} ( x ) 〉 \qquad ( 1 )$$

The optimization process based on the variational circuit parameter θ and the loss function may be regarded as a quantum machine learning process wherein the quantum circuit comprising the variational quantum circuit may define a plurality of mutually interacting qubits that can be adjusted variationally by (at least on) variational circuit parameter θ. This way, the plurality of mutually interacting qubits may define a parametrized quantum circuit that can be trained based on variational circuit parameter θ, training data and a loss function to approximate a function ƒ(x) for a certain value of variable x.

The differentiation of quantum feature map circuits may be defined by the following expression: dÛ(x)/dx=ΣⱼÛ_{dφ,j} (x), which allows the action differential to be represented as a sum of modified circuits Û_{dφ,j}. This way, function derivatives may be represented using a product derivative rule. Thus, in case of a quantum feature map generated by strings of Pauli matrices or any involutory matrix, the parameter shift rule may be used such that a function derivative may be expressed as a sum of expectations:

$$df ( x ) / dx = \frac{1}{2} {\sum }_{j} ( 〈 {f}_{d φ , j , θ}^{+} ( x ) \vert \hat{𝒞} \vert {f}_{d φ , j , θ}^{+} ( x ) 〉 - 〈 {f}_{d φ , j , θ}^{-} ( x ) \vert \hat{𝒞} \vert {f}_{d φ , j , θ}^{-} ( x ) 〉 ) , \qquad ( 2 )$$

with |uƒ_{dφ,j,θ}^{±}(x) [symbol] defined through the parameter shifting, and index j runs through individual quantum operations used in the feature map encoding. Applying the parameter shift rule once again a second-order derivative d²u(x)/dx² may be obtained with four shifted terms for each generator.

Importantly, to perform quantum circuit differentiation, the automatic differentiation (AD) technique may be used. AD allows to represent exact analytical formula for the function derivative using a set of simple computational rules, as opposed to the numerical differentiation. Since automatic differentiation provides an analytical derivative of the circuit in at any point of variable x, the scheme does not rely on the accumulated error from approximating the derivatives. Notably, all known prior art schemes for quantum ODE solvers involve numerical differentiation using Euler's method and finite difference scheme that suffers from approximation error, and often require fine discretization grid. The embodiments in this application alleviate this problem.

One of the aims of the embodiments is to define the conditions for the quantum circuit to represent the solution of differential equations, generally written as F[{dⁿƒ/dxⁿ}ₙ, {ƒₘ(x)}ₘ]=0, where the functional F[·] is provided by the problem. This demands that derivatives and nonlinear functions need to give net zero contribution. Hence, solving the differential equations may be written as an optimization problem using a loss function [symbol] _{θ}[dₓƒ, ƒ, x]. This corresponds to minimization of F[x]|_{x→x}_{ᵢ}, at the set of points {xᵢ}, additionally ensuring that the boundary conditions are satisfied. Once the optimal angles

$${θ}_{opt} = {arg min}_{θ} ( {ℒ}_{θ} [ {d}_{x} f , f , x ] ) \qquad ( 3 )$$

are found, the solution from Eq. (1) as a function can be produced. Hence, the embodiments in this application:
1. use quantum feature map encoding to overcome the complexity of amplitude encoding that is used in the prior art for preparing the solution at the boundary;
2. use automatic differentiation of the quantum feature map circuit, allowing to represent analytical function derivatives without imprecision error characteristic to numerical differentiation (finite differencing);
3. use variational quantum circuits to search for a suitable solution in the exponential space of fitting polynomials, thus resembling the spectral and finite element methods with exponentially improved scaling; and,
4. avoid the data readout problem, as the solution is encoded in the observable operator, such that expectation can be routinely calculated.

For the latter point, it differs from amplitude encoding |u [symbol] in HHL and related methods, where getting the full solution from amplitudes is exponentially costly and requires tomographic measurements.

One of the aims of the embodiments is to construct circuits that can work for quantum processors with limited computational power, meaning with the gate depth (number of operations to performed in series) being limited to a certain limited amount. The gate depth largely defines the training procedure, which is relied upon in the classical optimization loop. Alleviating the reduced depth problem, it is also possible to exploit parallel training strategies for the quantum circuit and quantum state encoding, coming closer to the ideal quantum operation regime.

Below quantum circuits are described that may be used to build differentiable circuit as a solution of differential equations. The quantum circuits include quantum feature maps and their derivatives; variational quantum circuits (ansatz); cost functions that define trial functions; and loss functions that are used in the optimization loop. Additionally, boundary handling techniques, regularization schemes, and a complete optimization schedule are described.

A quantum feature map is a unitary circuit Û_{φ}(x) that is parametrized by the variable x and typically nonlinear function φ(x). Acting on the state, it realizes a map x [symbol] Û_{φ}(x)|∅ [symbol] s.t. the x-dependence is translated into quantum state amplitudes. This is also referred as a latent space mapping. Different ways of feature map encoding exist. Below various examples are described including a Chebyshev quantum feature map that allows to approximate highly nonlinear functions. The procedure of feature map differentiation, as an important step in constructing quantum circuits for solutions of differential equations is also described.

In a first embodiment, a product feature map may be used that uses qubit rotations.

FIG. 3A-3C depict quantum circuits according various embodiments. In particular, FIG. 3A shows the basic form of a quantum feature map, which is here illustrated as an example of a ‘product’ type feature map, wherein single qubit rotations (here chosen as \hat{R}_{y}(φ[x])) act on each qubit individually and are parametrized by a function of variable x. Such operation may be referred to as a layer of rotation operations. Reading from left to right going forward in time, the rest of the circuit is schematically summarized, including the application of variational ansatz 304 and a cost function measurement 306 as described in more detail with reference to FIG. 6. For the nonlinear feature map encoding, the nonlinear function φ(x) may be used as an angle of rotation. The product feature map can be further generalized to several product layers, and different functions {φ}. For example, several feature maps may be concatenated to represent a multivariable function.

FIG. 3B illustrates an example of a derivative quantum circuit for the product feature map of FIG. 3A. Differentiation over variable x follows the chain rule of differentiation, including qubit operations 312 with shifted phases \hat{R}_{y} (φ[x]±π/2). Here, the expectation value of the derivative is written as a sum of separate expectations with shifted phases, repeated for each x-dependent rotation 310₁₋₄.

FIG. 3C depicts an example of a generalized product feature map, where the layer of rotation follows by the unitary evolution generated by Hamiltonian Ĥ 314. For complicated multiqubit Hamiltonians, the encoded state may comprise exponentially many unique x-dependent amplitudes. The time interval τ can be set variationally, or annealed from zero to a finite value during the optimization procedure.

Preferably, the product feature map has nonlinear dependence on the encoded variable x. In the simplest case, this may correspond to a single layer of rotations. Such product feature map may be described by the following expression:

$${\hat{𝒰}}_{φ} ( x ) = {{⊗}_{j = 1}}^{{N}^{′}} {\tilde{R}}_{α , j} ( φ [ x ] ) , \qquad ( 4 )$$

where N′≤N is a number of qubits that is used by the quantum computer for the encoding. Further,

$${\hat{R}}_{α , j} ( φ ) = exp ( - i \frac{φ}{2} {\hat{P}}_{α , j} )$$

is a Pauli rotation operator for Pauli matrices \hat{P}_{α,j}=\hat{X}ⱼ, Ŷⱼ or \hat{Z}ⱼ, (α=x, y, z, respectively) acting at qubit j for phase φ. As we consider rotations on different j here the symbol ⊗ⱼ denotes the tensor product. This type of feature map circuit is also used in Quantum Circuit Learning. The next step is to assign a nonlinear function for rotation. In an embodiment, the nonlinear function may be selected as φ(x)=arcsin x and α=y such that only real amplitudes are generated. The unitary operator of Eq. (5) may then rewritten as:

$${\hat{𝒰}}_{φ} ( x ) = {{⊗}_{j = 1}}^{N} exp ( - i \frac{arcsin x}{2} {\hat{Y}}_{i} ) . \qquad ( 5 )$$

leading to amplitudes that depend on the encoded variables as cos [(arcsin x)/2] and sin [(arcsin x)/2]. Acting on the initial state |θ [symbol] this feature map may encode the variable as an N-th degree polynomial formed by {1, x, \sqrt{1−x²}} and products [QCL]. The redundancy from many qubits thus forms a basis set for function fitting [S-S]. % We note that while basis set can be continuously improved adding more rotations, this choice of basis is well-suitable for linear and quadratic functions, but often lacks the expressive power.

The product feature map can be generalized to several layers of rotations [symbol] =1, 2, . . . , L, various nonlinear functions [symbol] , and specific subsets of qubits N written as:

$${\hat{𝒰}}_{φ} ( x ) = {\prod }_{ℓ = 1}^{L} {⊗}_{j ∈ {N}_{ℓ}} {\hat{R}}_{α , j}^{( ℓ )} ( {φ}_{ℓ} [ x ] ) . \qquad ( 6 )$$

Below an example of how the quantum feature map can be differentiated is provided, e.g. the example in Eq. (4) wherein α=y rotations and full layer are considered. The derivative for the unitary operator generated by any involutory matrix (length-1 Pauli string in this case) can be written as:

$$\begin{matrix}\frac{d}{dx} {\hat{𝒰}}_{φ} ( x ) = \frac{1}{2} ( \frac{d}{dx} φ ( x ) ) {\sum }_{{j}^{′} = 1}^{N} {{⊗}_{j = 1}}^{N} ( - i {\hat{Y}}_{{j}^{′}} {δ}_{j , {j}^{′}} ) {\hat{R}}_{y , j} ( φ [ x ] ) \\ = \frac{1}{2} ( \frac{d}{dx} φ ( x ) ) {\sum }_{{j}^{′} = 1}^{N} {{⊗}_{j = 1}}^{N} {\hat{R}}_{y , j} ( φ [ x ] + {πδ}_{j , {j}^{′}} )\end{matrix} , \qquad ( 7 )$$

where Euler's formula can be used to rewrite the derivative into the form of a sum of unitaries, where x-dependent rotations are shifted one-by-one. Next, the formula may be generalized to the expectation value of any observable [symbol] C [symbol] for the encoded state, following the step of standard parameter shift rule. This reads:

$$\frac{d}{dx} 〈 ∅ \vert {\hat{𝒰}}_{φ} ( x \text{?} \hat{𝒞} {\hat{𝒰}}_{φ} ( x ) \vert ∅ 〉 = \frac{1}{4} ( \frac{d}{dx} φ ( x ) ) ( {〈 \hat{𝒞} 〉}^{+} - {〈 \hat{𝒞} 〉}^{-} ) \qquad ( 8 )$$

$$\text{?} \text{indicates text missing or illegible when filed}$$

where [symbol] and [symbol] are the sum of shifted unitaries:

$$〈 \hat{𝒞} \text{?} = {\sum }_{{j}^{′} = 1}^{N} {{⊗}_{j = 1}}^{N} {\hat{R}}_{y , j} ( φ [ x ] \pm \frac{π}{2} {δ}_{j , {j}^{′}} ) \hat{𝒞} {\hat{R}}_{y , j} ( φ [ x ] \pm \frac{π}{2} {δ}_{j , {j}^{′}} ) . \qquad ( 9 )$$

$$\text{?} \text{indicates text missing or illegible when filed}$$

The corresponding derivative quantum circuits (DQC) are shown in FIG. 3B, where differentiation of the cost function for feature map is performed using the chain rule (highlighted rotations). A similar strategy can be applied for generic multilayer feature maps and a different choice of nonlinear map φ(x). Finally, in the cases where the generator of the feature map (encoding Hamiltonian Ĥ) is not an involutory matrix, they may be rewritten as a sum of unitary operators, and measure the derivative as a sum of overlap using the SWAP test.

In another embodiment, a nonlinear quantum feature map may be used which may be referred to as the Chebyshev feature map. Belonging to the product feature map family, this feature map drastically changes the basis set for function representation. As a building block a single qubit rotation \hat{R}_{y,j} (φ[x]) may be used, but with nonlinearity introduced as φ(x)=2n arccos x, n=0,1,2, . . . , such that the encoding circuit reads:

$${\hat{𝒰}}_{φ} ( x ) = {{⊗}_{j = 1}}^{N} {\hat{R}}_{y , j} ( 2 n [ j ] arccos x ) . \qquad ( 10 )$$

Here it is considered that the coefficient n[j] may in general depend on the qubit position. The seemingly small change of factor two multiplication goes a surprisingly long way. Namely, let us expand the rotation using Euler's formula, getting:

$${\hat{R}}_{y , j} ( φ [ x ] ) = exp ( - i \frac{2 n arccos ( x )}{2} {\hat{Y}}_{j} ) = cos ( n arccos ( x ) ) {j}_{} - i sin ( n arccos ( x ) ) {\hat{Y}}_{j} = {T}_{n} ( x ) {j}_{} + {U}_{n} ( x ) {\hat{X}}_{j} {\hat{Z}}_{j} . \qquad ( 11 )$$

The resulting decomposition of equation (11) corresponds to the unitary operation with matrix elements defined through degree-n Chebyshev polynomials of first and second kind, denoted as Tₙ (x) and Uₙ (x). Formally, Chebyshev polynomials represent a solution of Chebyshev differential equation:

$$( 1 - {x}^{2} ) \frac{{d}^{2} y}{{dx}^{2}} - x \frac{dy}{dx} + {n}^{2} y = 0 , n = 0 , 1 , 2 , 3 \qquad ( 12 )$$

wherein

$$\begin{matrix}y ( x ) = A cos ( n arccos ( x ) ) + B sin ( n arccos ( x ) ) \\ ≡ {AT}_{n} ( x ) + {BU}_{n} ( x ) , \vert x \vert < 1\end{matrix} , \qquad ( 13 )$$

and wherein A, B are some constants. Chebyshev polynomial of the first kind for low degrees can be written explicitly as T₀ (x)=1, T₁ (x)=x, T₂ (x)=2x²−1, T₃ (x)=4x³−3x, and higher degrees can be deduced using the recursion relation

$${T}_{n + 1} ( x ) = 2 {xT}_{n} ( x ) - {T}_{n - 1} ( x ) . \qquad ( 14 )$$

Similarly, second-kind Chebyshev polynomials can be written as U₀ (x)=1, U₁ (x)=2x, Uₙ₊₁(x)=2x, and Uₙ (x)−Uₙ₋₁ (x). The crucial properties of Chebyshev polynomials are their chaining properties, nesting properties, and simple differentiation rules. The chaining properties for polynomials of the first and second kind read as 2Tₘ (x)Tₙ(x)=Tₘ₊ₙ (x)+T_{|m-n|}(x) and Uₘ (x)Uₙ (x)=Σₖ₌₀ⁿUₘ₋ₙ₊₂ₖ (x), respectively. Derivatives can be obtained as dTₙ (x)/dx=nUₙ₋₁ (x). Nesting corresponds to the relation Tₙ (Tₘ (x))=Tₙₘ (x). Finally, polynomials of different kinds can be converted as Uₙ (x)=2ΣⱼⁿTⱼ (x) when j is even, and Uₙ(x)=2Σⱼⁿ[Tⱼ(x)−1] when j is odd. Finally, it is noted that Chebyshev polynomials may represent oscillating functions when defined in the x=(−1,1) region, and their derivatives diverge at the boundaries of this interval.

The power of the representation described can be inferred from the approximation theory. It states that any smooth function can be approximated as ƒ(x)=Σₙ₌₀^{∞}AₙTₙ (x), |x|≤1. Chebyshev polynomials form an optimal set of basis function in the sense of the uniform L_{≈} norm. This is why they are at the foundation of spectral algorithms for solving ODEs, and also give an edge in quantum simulation.

In examples described below, two types of Chebyshev quantum feature maps are considered. The first version corresponds to a sparse Chebyshev feature map defined as:

$${\hat{𝒰}}_{φ} ( x ) = {{⊗}_{j = 1}}^{N} {\hat{R}}_{y , j} ( 2 arccos x ) , \qquad ( 15 )$$

where encoded degree is homogeneous and is equal to one. Here the chaining properties Tₙ (x) and Uₙ (x) should be remembered, noting that once states with Chebyshev polynomials as pre-factors are created, the basis set will grow further by concatenating elements. In the following, the sparse distinction is dropped and simply refer to Eq. (15) as Chebyshev feature map. The second version corresponds to a Chebyshev tower feature map, which may be defined as:

$${\hat{𝒰}}_{φ} ( x ) = {{⊗}_{j = 1}}^{N} {\hat{R}}_{y , j} ( 2 j arccos x ) , \qquad ( 16 )$$

where the encoded degree grows with the number of qubit, creating a tower-like structure of polynomials with increasing n=j. Again, as polynomials chain together and morph between two kinds and their degrees, the basis set is largely enriched. This is the choice that is exploited when large expressibility is needed without increasing system size and number of rotations. Eq. (16) allows the representation of generic functions, and can be improved further by using layers of rotations as in Eq. (6).

Product feature maps may induce nonlinear mappings between variable(s) x and quantum states described by tensor products of separate single-qubit wavefunctions. These states are limited to the subspace of product states. To utilize the power of the entire Hilbert space of the system, approaching the amplitude encoding case, independently distinct amplitudes need to be populated, including the subspace of entangled states. To make the described feature maps even more expressive, it is suggested to enhance the product feature maps (and specifically the layered Chebyshev map) with additional entangling layers represented by Hamiltonian evolution. Namely, after the set of single qubit rotations another unitary exp(−iĤτ) may be considered which acts for time τ and is generated by the Hamiltonian Ĥ. The sketch of the circuit is shown in FIG. 3C. By choosing Ĥ as a complex many-body Hamiltonian, it is ensured that exponentially many amplitudes are generated. It is known that the quantum simulation of dynamics leads to a volume-like increase of entanglement.

One important choice is when Ĥ corresponds to a hard problem from NP-hard complexity class, as proposed. Then using two layers of rotations plus evolution the embedding becomes difficult to simulate classically, but can be implemented as unitary evolution on a quantum computer. The evolution-enhanced feature map can also be seen through the prism of a recently proposed Fourier feature maps, which are a class of quantum feature maps based on the evolution exp(−iĤ_{data,J}x), which is applied for qubits in J. The Fourier map allows functions to be encoded as Fourier series defined by the differences of the eigenvalues of Ĥ_{data}. The evolution-enhanced feature map then joins the Chebyshev and Fourier basis sets, encoded in the full Hilbert space for complex Ĥ.

In another embodiment, a variable may be encoded the data using a feature map by transforming it into the canonical amplitude encoding form. This relates x, written in binary form, to a computational basis state in binary representation. The corresponding feature map Û₁₀₀ (x) to encode the binary variable x reads

$${\hat{U}}_{φ} ( x ) = {⊗}_{j = 1}^{N} exp ( - i \frac{π}{2} {x}_{j} {\hat{X}}_{J} ) ,$$

where {xⱼ} denote binary values for the parameter x in j-th digit. The differentiation of the amplitude-encoding feature map then relies on the product rule for N rotations, and also includes the binary derivative of the variable from the product rule.

In a further embodiment, a variable may be converted into the decimal representation as xᵢₙₜ=Σᵢₙₜ=Σⱼxⱼ·2^{j}. For the reverse procedure, each binary digit xⱼ can be identified by the remainder of the repeated division xⱼ=mod(xᵢₙₜ, 2^{j}). Û_{φ}(x) thus can be rewritten as a function of xᵢₙₜ, and learn how to differentiate circuits with this feature map with respect to x=xᵢₙₜ.

Amplitude-encoding feature maps offer a powerful technique when dealing with functions of discrete variables and functions encoded as quantum wavefunctions (rather than expectation value). They can give an advantage in terms of compressing data to a quantum register.

To construct the solution of the differential equation as a quantum circuit we need to manipulate the latent space basis function and bring both derivatives and function to the required form. This is achieved through the variational circuit Û_{θ}, typically referred to as a quantum ansatz. Below various detailed architectures are described.

In an embodiment, a variational circuit Ĥ_{θ} one or more layers of parametrized rotations may be selected. These layers may be followed by layers of CNOT operations. This is known as a hardware efficient ansatz (HEA), which was proposed for variational quantum encoder VQE schemes for chemistry applications. The structure of a HEA quantum circuit corresponds to concatenated layers of single qubit rotations and global entangling layers for all N qubits or at least a large part thereof

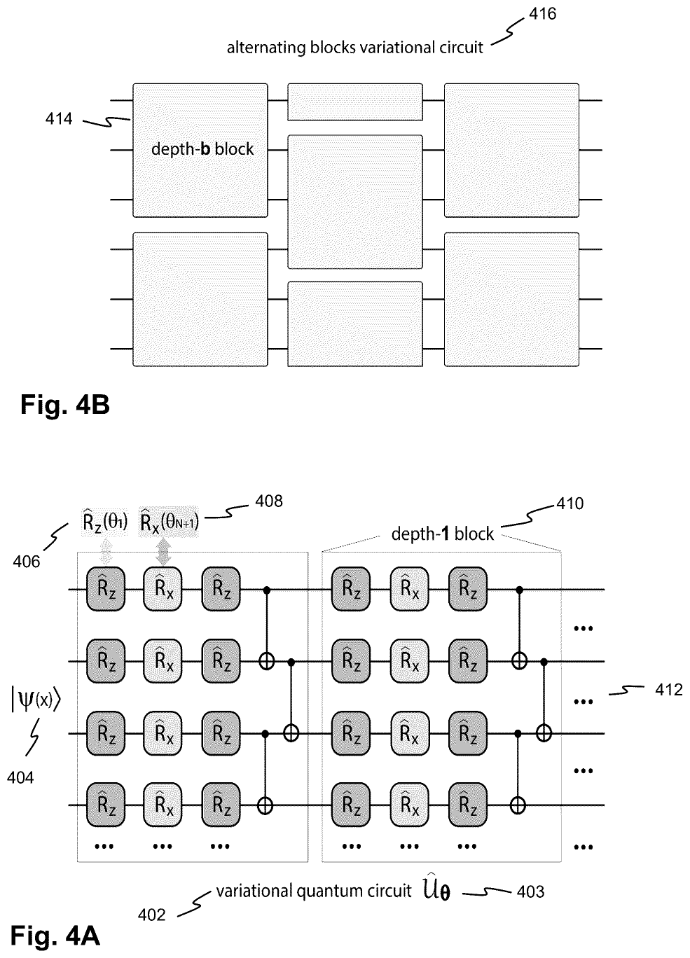

FIGS. 4A and 4B illustrate exemplary variational quantum circuits according to various embodiments. In particular, FIG. 4A shows a variational ansatz 402 in the so-called hardware-efficient form. It includes parametrized rotation layers forming an \hat{R}_{z}-\hat{R}ₓ-\hat{R}_{z} pattern, such that arbitrary single qubit rotations can be implemented. Variational angles θ are set for each rotation individually 406, 408. The rotation layer is applied to a qubit initial state |ψ(x) [symbol] 404 coming from the preceding quantum circuit, the feature map circuit. The variational rotations may be followed by one or more entangling layers, which may include controlled NOT (CNOT) operations between nearest-neighboring qubits. The blocks 410 of “rotations-plus-entangler” are repeated d times 412 to form a full variational circuit Û_{θ} 403.

FIG. 4B shows a more general form of alternating blocks ansatz 416, incorporating for example the hardware-efficient form circuit from FIG. 4A. The variational circuit may comprise of blocks of width M qubits (M/2 for boundary qubits). Blocks may be chosen in the hardware-efficient form as illustrated with a depth of b. The blocks may be placed in a checkerboard pattern, and repeated n_{b} times. The goal of this alternating-blocks strategy is to entangle qubits locally, while avoiding global entangling operations that would normally often result in vanishing gradients during the optimization of θ.

In a further embodiment, an alternating blocks ansatz (ABA) may be used, where instead of global entangling layers separate subblocks are used, interleaved into a checkerboard form as shown in FIG. 4B. Each subblock has a hardware efficient form shown in FIG. 4A for the specified depth b. For the first layer the width of the subblock (number of active qubits) may be equal to M such that [N/M] blocks are used (and is smaller than M if N/M is not an integer). The next layer may comprise (or consist of) the same subblocks, but is shifted by [M/2], where subblocks at the ends are adjusted to span all qubits. The described checkerboard structure may be repeated for d_{layers}. The motivation behind ABA is to entangle qubits locally first, and gradually form a correlated state by interleaving subblocks. Further, global entangling operations that would normally often result in vanishing gradients during the optimization of θ are avoided. This helps to improve trainability of the circuit together while maintaining high expressibility.

FIG. 2-4 show that both the feature maps and the variational quantum circuit ansatze typically require a large number of digital quantum gate operations, both single- and multi-qubit operations, and that qubits participating in the schemes should be entangled. It is noted that the choice of ansatz may be sensitive to the choice of cost function operator, as dictated by the symmetry. Namely, as a consequence of cost function choice non-commuting generators [symbol] for the variational ansatz need to be selected such that [ [symbol] ]≠0, where a generator is the rewritten form of a general unitary as Ûⱼ= [symbol] . Here, a generator refers to a quantum operator that acts on one or more of the qubits in a controlled fashion. It is quite a generic concept and cover basically any circuit, gate etc. This ensures that the solution space can be spanned. Also, symmetries may be taken into account, reducing the Hilbert space for the search. In many cases generators can be chosen such that only real amplitudes are generated. An adaptive strategy or a genetic search may also be used.

Further, to search for the optimal circuit parameters, a stochastic gradient descent scheme may be used, and specifically its adaptive version represented by Adam. For this, one or more gradients of the variational circuit ∇_{θ} [symbol] may be measured using the automatic differentiation approach. Choosing an ansatz parametrized by single-qubit rotations allows the application of the parameter shift rule, while overlap measurement opens up options for more general strategies.

To read out information a Hermitian operator may be selected to measure an observable. In general, different choices are available. In an embodiment, a Hermitian operator may comprise the magnetization of a single qubit j, [symbol] \hat{Z}ⱼ [symbol] . This suits functions with range bounded to [−1,1]. In another embodiment, a Hermitian operator comprising the total magnetization of the system Ĉ=ΣⱼZⱼ (with equal weights) may be selected.

In further embodiments, the cost may be selected as a quantum Hamiltonian that has a provably complex spectrum, and, for instance, belongs to ergodic phase. Such Hermitian operator may comprise an Ising Hamiltonian with additional transverse and longitudinal magnetic fields,

$$\hat{C} = {\sum }_{j} {J}_{j , j + 1} {\hat{Z}}_{j} {\hat{Z}}_{j + 1} + {h}_{j}^{z} {\hat{Z}}_{j} + {h}_{j}^{x} {\hat{X}}_{j} . \qquad ( 17 )$$

where the Ising couplings J_{j,j+1} and hⱼ^{z,x}, can be inhomogeneous. For cost functions with several non-commuting groups of observables the Hamiltonian averaging procedure may be used, where term-by-term measurement may be performed. Instead of nearest-neighbour Hamiltonians, in an embodiment, spin-glass type cost functions may be used, which may have the form

$$\hat{C} = {\sum }_{i < j} {J}_{i , j} {\hat{Z}}_{i} {\hat{Z}}_{j} + {\sum }_{j} {h}_{j}^{z} {\hat{Z}}_{j} . \qquad ( 18 )$$

These are known to include NP-hard problem instances, and allows for high expressibility of the circuit describing the DEs solution. Finally, a generic cost function may comprise a large set of Pauli strings, similar to, for instances, in quantum chemistry.

Together with measuring individual cost functions, functions being represented by classically weighted sum of observables may also be considered. Such cost function may have the form

$$\hat{C} = {\sum }_{ℓ} {α}_{ℓ} {\hat{C}}_{ℓ} , \qquad ( 19 )$$

where α₁ ∈R are weighting coefficients, and [symbol] are cost functions that can be chosen from the pool of operators described above. The coefficients may be tunable, such that the gradient descent (represented by Adam in our case) can adjust the cost to have optimal form. This procedure further improves the strength of the hybrid quantum-classical workflow. To solve the system of differential equation a means needs to be provided that allows to measure (e.g. in terms of a distance) how well the differentiable quantum circuit matches the conditions to be the solution of the problem being considered. The classical optimizer then updates the parameters to reduce this distance. This distance corresponds to the difference between the differential equation and zero evaluated at a set of points, as well as matched initial and boundary conditions. This can be reformulated as an optimization problem for a loss function of derivatives and functions evaluated at the grid of points.

A loss function parametrized by variational angles θ in the following example form may be used

$${ℒ}_{θ} [ {d}_{x} f , f , x ] = {ℒ}_{θ}^{( diff )} [ {d}_{x} f , f , x ] + {ℒ}_{θ}^{( boundary )} [ f , x ] , \qquad ( 20 )$$

where the loss contribution from matching the differentials [symbol] _{θ}^{(dt)} and the loss contribution from satisfying the boundary conditions [symbol] _{θ}^{(budr)} may be splitted. The differential loss is defined as

$${ℒ}_{θ}^{( diff )} [ {d}_{x} f , f , x ] = \frac{1}{M} {\sum }_{i = 1}^{M} L ( F [ {d}_{x} f ( {x}_{i} ) , f ( {x}_{i} ) , {x}_{i} ] , 0 ) \qquad ( 21 )$$

with L(a, b) being a function describing how the distance between the two arguments a and b is being measured. The loss may be estimated on a grid of M points, and is normalized by the grid size. Functional F corresponds to the differential equation written in the form F[dₓu,u,x]=0. It can be evaluated by combining values of ƒ and d_{xƒ} at the training grid points. The functional includes information about all differential equations when dealing with the system, such that contributions from all equations are accounted for. The boundary loss contribution reads

$${ℒ}_{θ}^{( boundary )} [ f , x ] = η L ( f ( {x}_{0} ) , {u}_{0} ) \qquad ( 22 )$$

which includes the distance between the function value at the boundary x₀ and given boundary value u₀. It is noted that x₀ can be an initial point or a set of boundary points. A boundary pinning coefficient η may be used to control the weight of the boundary term in the optimization procedure. In particular, larger η>1 may be used to ensure the boundary is prioritized and represented to higher precision.

Different choices of the loss defined by three distance definitions L may be used. In an embodiment, a loss type corresponding to the mean square error (MSE) may be used:

$$L ( a , b ) = {( a - b )}^{2} . \qquad ( 23 )$$

While being simple, MSE performs sufficiently well in numerical simulations. In a further embodiment, a mean absolute error (MAE) may also be used as a loss defined with distance L(a, b)=|a−b|.

In further embodiments, several more complex metrics may be used, including the variants of Kullback-Leibler (KL) divergence and Jensen-Shannon divergence. These are well known loss functions that are routinely used in statistical modelling.

The choice of loss functions dictates how the optimizer perceives the distance between vectors and therefore affects the convergence. MSE places a greater emphasis on larger distances and smaller weight on small distances, strongly discouraging terms with large L. Both MAE and KL do not place such an emphasis and may have slower convergence. However, once close to the optimal solution they can achieve higher accuracy than MSE. KL has an additional incentive for keeping the magnitude of the first argument low, which for the differential loss term works well as one want to match the differential equation to zero.

Constructing a quantum circuit that satisfies differential equations, together with matched derivatives it needs to be ensured that an initial value or boundary value problem is solved. Generally this corresponds to setting the function value at the required initial point or the collection of boundary points, thus resembling the quantum circuit learning task [QCL]. At the same time, there are several ways how the DQC-based function ƒ_{θ}(x) can be constructed, leading to varying performance and specific pros/cons when solving particular problems.

Information about the boundary can be included as part of the loss function as defined by Eq. (20). For a MSE loss function type the boundary part Eq. (22) can be written in the form

$${ℒ}_{θ}^{( boundary )} [ f , x ] = {η ( {f}_{θ} ( {x}_{0} ) - {u}_{0} )}^{2} , \qquad ( 24 )$$

where x₀ represents the set of boundary points (or an initial point), and u₀ is a vector of boundary values, and η is a pinning coefficient as described above.

In an embodiment, information about the boundary may be included in the expectation of the cost function. This may be referred to as pinned boundary handling. This corresponds to simply choosing a cost operator [symbol] , and representing the solution in the form

$$f ( x ) = 〈 {f}_{φ , θ} ( x ) \vert \hat{𝒞} \vert {f}_{φ , θ} ( x ) 〉 . \qquad ( 25 )$$

The initial value u₀ is then matched to via the boundary term in the loss function. The strength of the pinned boundary handling is in the equivalent treatment of boundary and derivative terms, both being encoded in the eigenspectrum of [symbol] . At the same time, it needs adjusting the boundary value starting from the one represented by initial θᵢₙᵢₜ, typically generated randomly. This can be adjusted by shifting ƒ(x) by a constant-times-identity term added to the cost operator, [symbol] =α₀∥+Σⱼ₌₁^{M}αⱼ [symbol] , where α₀ is set such that for θᵢₙᵢₜ˜random [0,2π] the function [symbol] ƒ_{φ,θ}_{ᵢₙᵢₜ} (x)| [symbol] |ƒ_{φ,θ}_{ᵢₙᵢₜ}(x) [symbol] typically lies close to u₀ value when evaluated at x=x₀.

In a further embodiment, a boundary handler may correspond to iteratively shifting the estimated solution based on the boundary or initial point. For this method the boundary information does not require a separate boundary loss term nor is it encoded in the expectation of the cost function. Instead it is set iteratively within the parametrization of the function. This method does lead to additional terms in the function and in derivatives calculated and so information about the boundary is contained within [symbol] _{θ}^{(df)}[dₓƒ, ƒx] itself. The function may be parameterized as

$$f ( x ) = {f}_{b} + 〈 {f}_{φ , θ} ( x ) \vert \hat{𝒞} \vert {f}_{φ , θ} ( x ) 〉 , \qquad ( 26 )$$

with ƒ_{b}∈R being a parameter adjusted after each iteration step as

$${f}_{b} = {u}_{0} - 〈 {f}_{φ , θ} ( {x}_{0} ) \vert \hat{𝒞} \vert {f}_{φ , θ} ( {x}_{0} ) 〉 . \qquad ( 27 )$$

This effectively allows the solver to find a function [symbol] ƒ_{φ,θ}(x)| [symbol] ƒ_{φθ}(x) [symbol] which solves the differential equation shifted to any position, then being shifted to the desired initial condition as shown in Eq. (26). This method of boundary handling guarantees exact matching to initial values given and does not require a separate boundary term in the loss function, thus the derivative loss term does not have to compete with the boundary loss. Furthermore, as the cost function may be allowed to match to the solution shifted by any amount, this simplifies the choice for optimal angles and removes the dependence on initial einit. However, this method does require to have an exact initial value which can be an issue in specific situations.

In a further embodiment, a boundary handing technique may be used that relies on the classical shift of the solution, but defined by the gradient descent procedure on par with variational angles optimization. This removes the need to include boundary information in the cost expectation, but information needs to still be included in the loss function whether via a boundary loss term or regularization. Thus, a solution in the form

$$f ( x ) = {f}_{c} + 〈 {f}_{φ , θ} ( x ) \vert \hat{𝒞} \vert {f}_{φ , θ} ( x ) 〉 , \qquad ( 28 )$$

Is sought for, where ƒ_{c}∈R is a variational parameter alongside the quantum ansatz angles and updated accordingly via the classical optimizer, therefore the gradients for ƒ_{c} have to be calculated additionally when using this boundary handler. Strengths of the described method are that due to the classical shift even if the random initial angles start such that [symbol] ƒ_{φ}, θᵢₙᵢₜ(x₀)| [symbol] |ƒ_{φ,θ}_{ᵢₙᵢₜ}(x) [symbol] is far from the initial value u₀, the optimizer can quickly and easily update ƒ_{c} to rectify this. In some cases however the boundary and differential terms in the loss may compete against one another.

Given that the aim is to find a variational spectral representation of the differential equations solution using large basis sets, the optimization procedure benefits from having a good initial guess, or “pre-trained” DQCs. This can be achieved by introducing the regularization procedure, also helping avoid getting the optimizer trapped in local minima.

The variants of the regularization procedure include: 1) feeding-in prior information about the potential solution; 2) biasing the DQC-based solution into a specific form; 3) searching solution in the region close to the boundary values, and feeding-in points from the first training into next sessions. The input for procedures 1) and 2) include regularization points for the variable(s) {x_{reg}}ᵣ₌₁^{R}, together with corresponding function values {u_{reg}}ᵣ₌₁^{R} for R points. Similarly, regularization based on the derivative values may be considered. A simple strategy may be employed wherein an additional contribution to the loss function comes from the regularization points, [symbol] _{θ}^{(reg)} [ƒ, x]. This loss is defined such that DQC-based function matches the regularization values at corresponding grid points. This has a form analogous to the boundary loss contribution. Using MSE loss as example, the regularization contribution reads

$${ℒ}_{θ}^{( reg )} [ f , x ] = {\sum }_{r = 1}^{R} ζ ( {n}_{j} ) {( {f}_{θ} ( {x}_{reg , r} ) - {u}_{reg , r} )}^{2} , \qquad ( 29 )$$

where ζ(nⱼ) is introduced as an iteration step-dependent regularization weight, and thus denoting an optimization schedule. In general, higher emphasis on the regularization-based training at initial stages may be required, which shall diminish to zero at higher iteration numbers. This allows to use a prior information at first, setting a rough solution or preferred function behavior, followed by precise derivative loss optimization at later training stages.

One possible choice of an optimization schedule corresponds to linearly decreasing regularization weight, ζ(nⱼ)=1−nⱼ/nᵢₜₑᵣ, where nⱼ is current iteration number and niter the maximum iteration number. This strategy works for small learning rates and large number of iterations, such the optimizer has sufficient “time” to adjust to the constantly changing loss landscape. Another choice corresponds to the reverse sigmoid optimization schedule}, where a smooth drop of regularization weight is performed at pre-defined training stage. This schedule may be parameterized as

$$ζ ( {n}_{j} ) = 1 - tanh ( \frac{{n}_{j} - {n}_{drop}}{{δ}_{j} {n}_{iter}} ) \qquad ( 30 )$$

where n_{drop} denotes the iteration step number at which regularization weight drops, and δⱼ assigns the transition rate. This allows the DQC to initially focus almost entirely on the regularization optimization, later switching the focus on the gradient optimization.

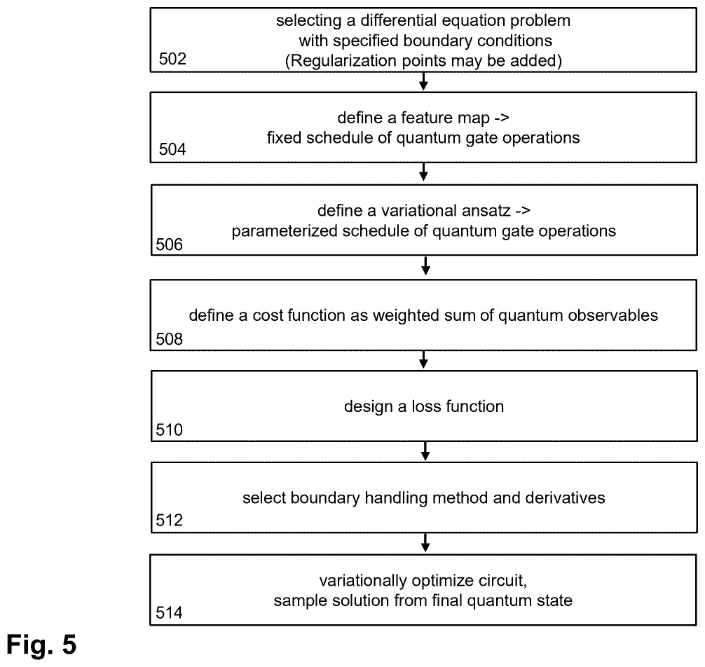

Finally, using the elements and strategies described above, a workflow for constructing the differential equation solver based on derivative quantum circuits described. FIG. 5 schematically depicts a flow diagram of a method for solving general (non-) linear DEs using quantum computation according to an embodiment. The process may start by specifying the input for a solver 502. This comprises the problem in hand, specified as a set of (non-) linear differential equations of various types, together with their respective boundary conditions. Additionally, a set of regularization points may be added to ensure the optimized solution is chosen in the desired qualitative form. Next, a schedule for derivative quantum circuit optimization may be set up, including the selection of the quantum circuit composition. To that end, a quantum feature map 504 may be defined. Further, an Ansatz of a variational quantum circuit, including its depth 506 may be defined. Additionally, a cost function type may be selected, also choosing if variational weights are considered. Then, a loss function 510 may be selected, which may include a scheme to match the boundary terms 512 and derivatives. Further, a classical optimizer (in short an optimizer) for variational angles and weights (with associated hyperparameters) needs to be defined, including number of iterations and exit conditions. An optimizer refers to an algorithm that is configured to optimize a cost or loss function as a function of variational parameters. Then, the quantum circuit may be variationally optimized in a quantum-classical hybrid loop and thereafter the solution may be sampled from the optimized quantum state 514.

FIG. 6A-6B depict a method for solving general (non-)linear DEs using a quantum computer according to an em. In particular, FIG. 6A. After determining the quantum circuits and optimization schedule, several initialization steps need to be made 604. First a set of points {X} (a regular or a randomly-drawn grid) may be specified for each equation variable x 606. The variational parameters θ are set to initial values (e.g. as random angles). Then, an expectation value [symbol] C(x,θ) [symbol] over variational quantum state |C_{φ,θ}(xⱼ) [symbol] for the cost function may be estimated 610, using the quantum hardware, for the chosen point xⱼ. Then, a potential solution at this point may be constructed taking into account the boundary conditions.

The derivative quantum circuits may be determined 611 and their expectation value d [symbol] C(x, θ) [symbol] /dx is estimated 610 for the specified cost function, at point xⱼ. Repeating the procedure 606 for all xⱼ in {X}, function values and derivative values may be collected, and the loss function is composed for the entire grid and system of equations (forming required polynomials and cross-terms by classical post-processing) as shown in 612. The regularization points are also added, forcing the solution to take specific values at these points. The goal of the loss function is to assign a “score” to how well the potential solution (parametrized by the variational angles θ) satisfies the differential equation, matching derivative terms and the function polynomial to minimize the loss.

With the aim to increase the score (and decrease the loss function), we also compute the gradient of the loss function 612 with respect to variational parameters θ. Using the gradient descent procedure (or in principle any other classical optimization procedure 614), the variational angles may be updated from iteration nⱼ=1 into the next one nⱼ+1 in step 616: θ⁽ⁿ^{ⱼ})←θ⁽ⁿ⁺¹⁾−α∇_{θ} [symbol] (with a being here a ‘learning’ rate). The above-described steps may be repeated until the exit condition is reached. The exit condition may be chosen as:
1) the maximal number of iterations niter reached;
2) loss function value is smaller than pre-specified value; and
3) loss gradient is smaller than a certain value.

Once the classical loop is exit, the solution is chosen as a circuit with angles θₒₚₜ that minimize the loss. Finally, the full solution is extracted by sampling the cost function for optimal angles [symbol] u_{φ,θ}(x)| [symbol] |u_{φ,θ}(x) [symbol] . Notably, this can be done for any point x, as DQC constructs the solution valid also beyond (and between) the points at which loss is evaluated originally.

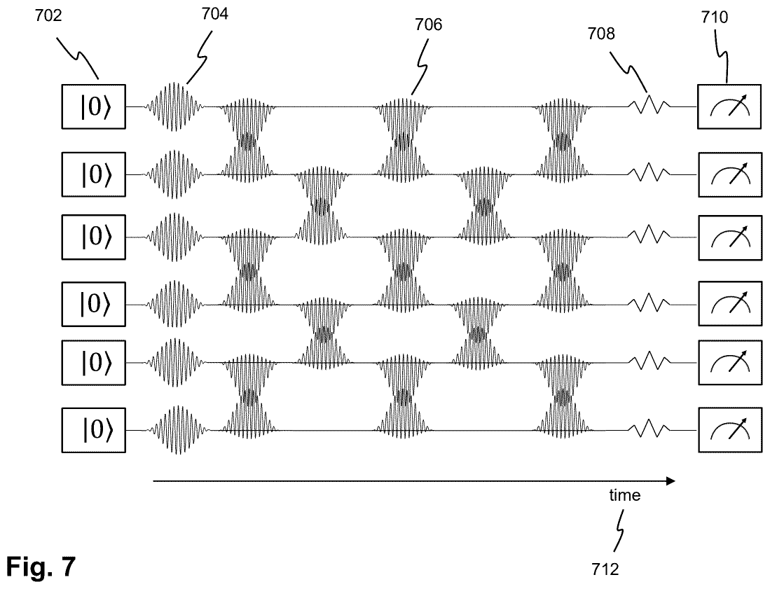

FIG. 7. is a hardware-level schematic illustrating the application of logical operations to qubits using a quantum circuit according to the embodiments in this application. The ansatz and variational unitaries, 704 and 706 respectively, can be decomposed into a sequence of logical gate operations. These logical gate operations are transformations in the quantum Hilbert space over the qubits. In order to transform the internal states of these qubits, a classical control stack, i.e. a quantum computer controller, is used to send pulse information to a pulse controller that affects one or more qubits. The controller may send a sequence of such pulses in time and for each qubit independently. For example, an initialization pulse may be used to initialize the qubits into the |0>state 702. Then, for example a series of single-qubit pulses may be sent to the qubit array in 704, which may represent the application of a single-layer feature map. Then, two-qubit pulse sequences may be used to effectively entangle multiple qubits 706. The duration, type, strength and shape of these pulses determine the effectuated quantum logical operations. The way the qubit should interact is defined by the quantum feature map circuit and the quantum variational circuit. Reference 708 indicates a ‘break’ in the depicted timeline, which means the sequence of gates may be repeated in a similar fashion in the direction of the time axis 712. At the end of the pulse sequences, the qubits are measured 710.

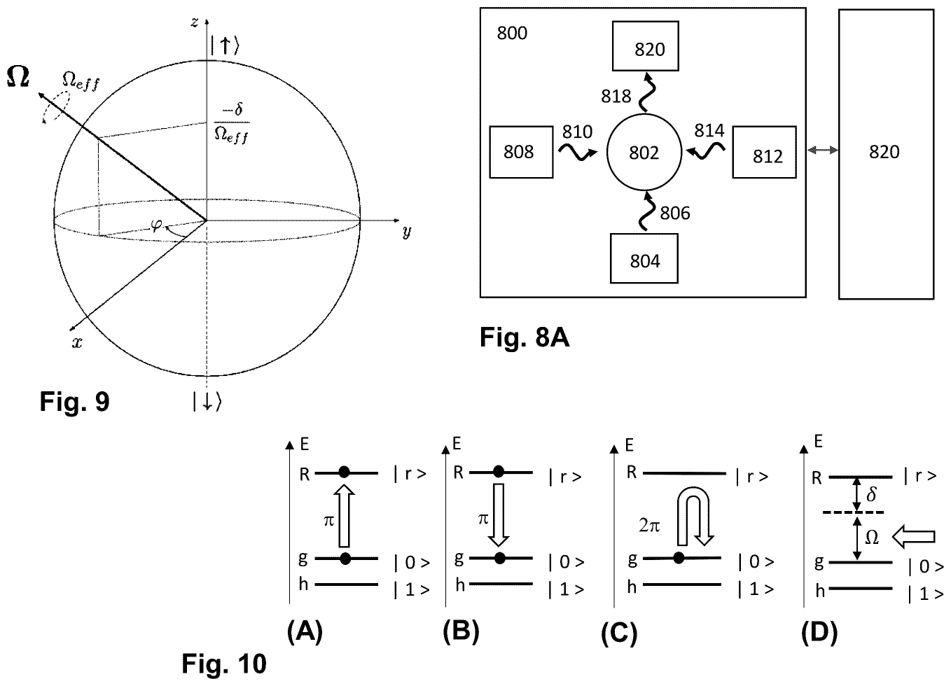

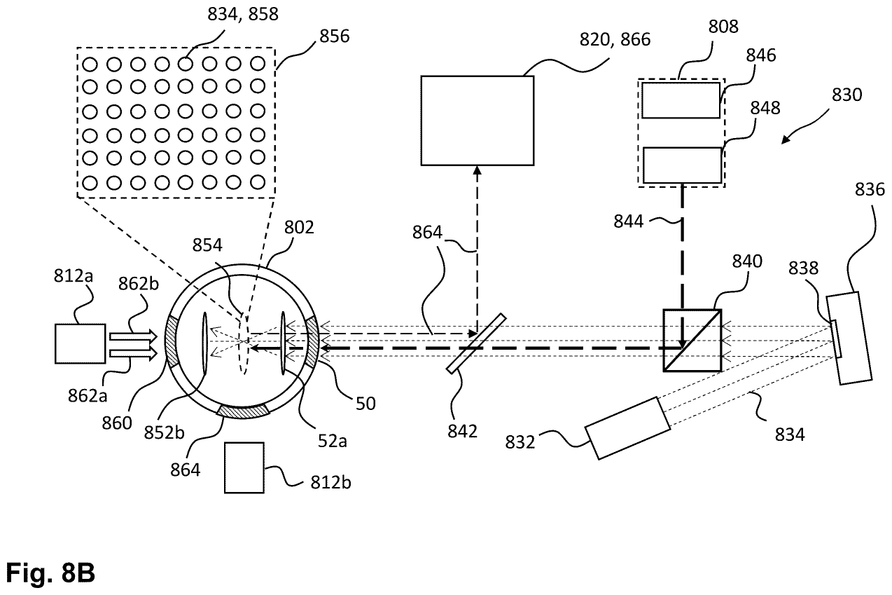

One particular promising candidate for implementing and executing the quantum circuits as described in this application, is a neutral atom quantum processor based on configurable arrays of single neutral atoms (a neutral atom register). FIGS. 8A and 8B schematically describe an example of such neutral atom quantum processor. In particular, FIG. 8A depicts a high-level schematic of a neutral atom quantum processor 800 (quantum processor) which is controlled by a classical computer 820 and which is configured to execute the quantum circuits as described with reference to the embodiments in this application.

The quantum computer may include a chamber 802 that accommodates a plurality of neutral atoms. The atoms may be of the same element, and thus are, from a chemical standpoint, identical when no external interactions are imposed upon them. The atoms may be unbound to other atoms in the group, for example, by being in a gaseous matter state. Particular suitable atoms that can be used as qubits and which are suitable for trapping, positioning and atomic-state-manipulating may include (but not limited to) Rubidium or Cesium or Strontium (Alkali, Alkaline Earth, . . . ).

To control the quantum processor to execute operations, it may include different control and readout modules as shown in the figure. In particular, the quantum processor may include amongst others a trapping system 804 configured to trap atoms in a particular spatial arrangement within the chamber, an atom positioner 808 configured to controllably move one or more trapped atoms from one spatial position to another spatial position, an atomic state actuator 812 or in short an actuator configured to generated optical control pulses to control and manipulate the atomic states of atoms in the chamber, and a detector 820 configured to detect and capture optical signals 818 transmitted by the atoms in the chamber. The detector may comprise a camera to image the fluorescence output by the atoms held by the holding system.

The trapping system 804 may be configured to trap atoms in a particular spatial arrangement. In particular, the trapping system may be configured to position (trap) each atom of the group of atoms at a particular position in the chamber such that they form a predetermined spatial arrangement in which atoms are isolated from each other if they are in a non-excited state, while atoms within a certain region may interact if they are in an excited state. Hence, the term ‘isolate’ in this context means that an atom in a non-excited atomic state does not interact with a neighboring atom of the same group.

However, if the atoms are stimulated using, for example, an electromagnetic signal such as a laser pulse, they may be brought into an excited state, in which the atoms may interact with each other based on quantum mechanical effects such as (but not limited to) the Rydberg blockade.

The trapping system may be configured to maintain the atoms in their stationary positions using different mechanisms including, but not limited to, magnetically traps and optical traps. The trapping system may be configured to generate a pattern of spatially separated traps so that a particular spatial arrangement of atoms in the chamber can be realized. The trapping pattern may be an array of regular or irregular spaced traps. The trapping patterns may include 1D, 2D (insofar that the traps in the pattern all align along one plane) or 3D patterns of traps. For example, the trapping system may generate a 3D array of traps spaced periodically in the X, Y and Z dimensions to form a 3D grid. Other patterns are also possible. The spacing in one spatial dimension may be the same or different to the other spatial dimensions.

The trapping system may provide a plurality of trapping sites wherein, when the trapping system is first activated some trapping sites may be filled by one or more atoms whilst other trap sites are vacant. Preferably the trapping system may be configured to generate trapping sites that hold a single atom. The trapping system may use electromagnetic signals 806, such as optical trapping signals to generate the optical traps in the chamber.

The atom positioner 808 may be configured to controllably move one or more held atoms from one spatial position to another spatial position. For example, in an embodiment, the atom positioner may include one or more optical tweezers configured to use optical signals 810 to move one or more trapped atoms in one of the trapping sites to another trapping site. Different technologies may be used to manipulate the position of the atoms including, but not limited to, moving the atoms using magnetic signals or electromagnetic signals such as optical signals.

The atomic state actuator 812 may be configured to generate optical pulse signals to control and manipulate the atomic states of atoms in the chamber (in other words it “actuates” the transition between atomic states). The optical pulse signal 814 may include single or multiple photon signals. Different optical pulse signals may be output by the atomic state actuator including optical pulse signals at different wavelengths. Each wavelength may correspond to (i.e., be resonant with) a different atomic transition. Typically, the quantum processor may comprise multiple atomic state actuators. For example, a first atomic state actuator may output a first wavelength or first set of wavelengths which are different from the wavelength or set of wavelengths outputted by a second atomic state actuator. The atomic state actuator may facilitate the transition between atomic states of a single trapped atom or a plurality of trapped atoms. The wavelengths may be selected based on the atoms in the chamber. The excitation from the ground state to the Rydberg state may be facilitated by two-photon absorption. This may be accomplished using two different EM sources such as lasers or other EM sources. These two EM sources may have different wavelengths. For example, optical control pulses of 495 nm may be used for exciting a Rubidium atom to the Rydberg state and optical control pulses of 795 nm to induce transitions between the hyperfine states.

Suitable signals for trapping and moving the atoms are preferably different, at least in wavelength, to the signals used to manipulate the quantum states of the atoms. In particular, signals for trapping and moving the atoms may be off-resonance, i.e., the wavelength of the optical signals for trapping and positioning an atom cannot excite the atom between its different atomic states.

An example of the general operation of the quantum processor may include one or more of the following steps.
1) Using the trapping system to generated optical trapping signals to create a plurality of traps in the chamber so that atoms in the chamber are trapped.
2) Optionally using the atom positioner to manipulate, e.g. move, trapped atoms so that each trap of at least a predetermined set of traps can be filled with a single atom. Such set of single atom filled traps may be referred to as a ‘register’. The detector may be used in this process to help identify which traps are occupied or vacant.
3) Using the atomic state actuator to generate predetermined optical control pulses 814, e.g. laser pulses of a predetermined shape, amplitude and duration to control the atomic states of atoms in the register. This step may be performed multiple times to implement processing operations of the quantum processor, for example, time-sequentially inputting a plurality of optical pulses that represent quantum logic gate operations.
4) Using the detector to detect and image florescent signals emitted by the atoms and using the imaged signals to determine the atomic states of the atoms.

These steps may represent a quantum computation by the quantum processor. The quantum processor may be re-set by removing the traps and re-initialised for a further quantum computation by repeating steps 1-4 above.

FIG. 8B depicts a specific example of a neutral atom quantum processor 830 (a quantum processor) wherein the chamber 802 may be a vacuum chamber comprising a dilute atomic vapour that is formed inside the chamber. The chamber may be an ultra-high vacuum system operating at room temperature, however other temperatures inside the chamber may be used as well. The example in FIG. 8B is just one example of a set-up for a neutral atom quantum processor that is configured to generate a 2D array of optical trapping sites, however other set-ups may be used, for example to implement a 3D array of trapping sites by including a plurality of the below-mentioned components and different component locations and/or configurations.

A laser system 832, comprising a laser and beam-expanding optics, may generate a cross-sectionally-wide collimated laser beam 834 towards a spatial light modulator (SLM) 836. The SLM and the laser system may form a holding system as described with reference to FIG. 8A. The SLM comprises a 2D periodic array of controllable deformable mirrors 838 which receive the collimated beam and selectively reflect portions of the beam towards a polarising beam splitter (PBS) 840. The SLM outputs an adjustable phase pattern on the light 834, that is converted into an intensity pattern 858 by first lens 852a which will be described hereunder in more detail. The polarization of the reflected portions of the beam may pass through the PBS and propagate towards a dichroic mirror 842. It is understood that the laser system may comprise further components such as a polarization rotator (not shown) for controllably adjusting the polarization of output light incident upon the SLM, so that the polarization of the light is aligned to the transmission axis of the PBS.

The PBS also receives electromagnetic signals from an atom positioner 808 comprising a laser 846 and a 2D acousto-optic laser beam deflector 848 that receives laser light from the laser 846 and controls the direction of the laser light into the PBS. In turn, this allows the deflector to use the laser light 844 as an optical tweezer or an array of optical tweezers. The light 844 output from the atom positioner 808 is reflected by the PBS such that it is output from the PBS along a substantially similar path to the light 834 output from the PBS that originates from the laser system 832. The light beams 834 and 844 may at least partially overlap in space when output from the PBS. The light 844 originating from positioner that is reflected and output by the PBS is incident upon the dichroic mirror 842.

Both the light 844 and 834 output from the PBS pass through the dichroic mirror 842 and are incident upon window 850 of the chamber. The window may be one of a plurality of windows in the chamber that are at least partially transparent to the wavelengths of the light that are incident upon them that are generated by the electromagnetic sources of the system. The window may form part of the body of the chamber and is sealed with respect to the walls of the chamber such that the chamber holds a vacuum environment within it.

Other components may be associated with the vacuum chamber by either being inside the chamber, integrated with the chamber or immediately surrounding the chamber insofar that the components may input stimuli into the chamber, such as electromagnetic fields or magnetic fields. One or more magnetic coils (not shown) may be included about the chamber to provide a spatially-varying magnetic field that, with the laser light 834, acts to provide a magneto-optical trap (MOT). The laser light may have a wavelength configured to cool the atoms via the mechanism of doppler cooling. The light may be split and/or reflected by other optical components (not shown) to provide a plurality of beams propagating along different directions that intersect the trapping area 854. Such beams may be used to provide cooling in a plurality of directions such as along X, Y, and Z cartesian axes. Further laser light beams from one or more further sources may be used to cool and trap the atoms. The coils may comprise two coils in an anti-Helmholtz configuration that are used to generate a weak quadrupolar magnetic field to facilitate, with the laser light, the magneto-optical trap. The quantum processor may use different forms of trapping mechanisms and associated equipment to trap the neutral atoms, as known in the art, for example, but not limited to any of the trapping and cooling systems described in: “Harold J Metcalf and Peter van der Straten. Laser cooling and trapping of atoms. JOSA B, 20(5):887-908, 2003” the entire contents of which are included herein by reference.

Inside the chamber are a pair of convex lenses, a first lens 852a and a second lens 852b. The first lens is positioned to receive light beams passing through the window 850 and focus them both onto a trapping area 854 of minimum beam waist (i.e., at the focal plane of the first lens). The second lens is located on the opposite side of the focal plane and captures light exiting the trapping area and focusses or collimates the light into a plurality of light beams that may be incident upon: a beam dump inside the chamber (not shown) or another chamber window 860 that allows the light to escape the chamber. An expanded view 856 of the focal plane in area 854 shows an array of optical trapping sites 858 that are created from the mirrors 838 of the SLM reflecting portions of the light 834.

The quantum processor may further comprise atomic state actuators, e.g. a first atomic state actuator 812a (first actuator) and a second atomic state actuator 812b (second actuator) each of which may be implemented as one or more lasers that output light for manipulating the states of the atoms trapped at the trapping sites. First actuator may be a system comprising at least two lasers, each laser outputting a first optical pulse signal 862a and a second optical pulse signal 862b at two different wavelengths, wherein the different wavelengths match different atomic transitions of the atomic system (or ‘ensemble’) held in the chamber. The optical pulse signals from the first actuator may be incident upon chamber window 860, through which the signals travel and are incident upon the second lens 852b. The second lens focusses the optical pulse signals onto the atoms in the trapping sites. The second actuator 812b may be positioned, about the plan view of the chamber, orthogonally to the first actuator. This second actuator may be configured to transmit a second light pulse via a further chamber window 864 into the chamber. The second actuator may be used to help address and manipulate atoms, particularly when the system provides a 3D array of optical traps. The optics for focussing light inside the chamber from the second actuator is not shown in the figure.

It is to be understood that FIG. 8B and its accompanying description is an example of a neutral atom quantum processor. The atomic state actuators may be positioned in different locations, including inside or outside the chamber or part of the chamber. There may also be one or a plurality of different actuators. The actuators may be integrated or otherwise co-located with other electromagnetic sources such as the laser 846 or laser system 832. It is also to be understood that the quantum processor may include other optical or electronic components and/or configurations to allow the neutral atoms to be addressed by the different electromagnetic sources.

Light, for example fluorescence light, emitted by the trapped atoms may exit the chamber through any of the windows 850, 864, 860. The emitted light may be collimated by the first lens into an output light signal before exiting window 850. The output light may be incident upon the dichroic mirror which reflects the light towards a camera 866 (which is equivalent to the detector 820 in FIG. 8A). In an embodiment, the camera may be an electron-multiplying charge-coupled-device (EMCCD) camera. Further, in an embodiment, the dichroic mirror may have an edge or pass-band characteristic filter response that substantially reflects the output light signal 64 but substantially transmits light 834 and 840.

The quantum processor may be operated by controlling the different different control and readout modules as described with reference to FIGS. 8A and 8B.

The atoms in the chamber are initially not in an arrangement suitable for performing quantum computing operations. To get the atoms in an arrangement for quantum processing, a 3D MOT is initiated, as described above, wherein a cold ensemble of 106 atoms with a 1 mm³ volume is prepared inside the trapping area 854. This array of atoms may be referred to as a ‘register’ and steps of locating atoms in the trapping sites may be referred to as ‘register loading’. The optical tweezers may be used to isolate individually trapped atoms in the ensemble. The trapping volume of a tweezer may be between 1-10 mm³ or generally in the order of a few mm³. Such a volume may trap at most one atom at a time. The number and arrangement of tweezers may be in any 1D, 2D or 3D pattern. The tweezers may be realized by holographic methods known in the art such as, but not limited to that described in: “Florence Nogrette, Henning Labuhn, Sylvain de Leseleuc, Thierry Lahaye and Antoine Broaeys. Synthetic three-dimensional atomic structures assembled atom by atom. Nature 561 (7721): 79-82, September 2018”; the entire contents of which are included herein by reference.

When first initiated, the trapping sites of the register may each hold an atom, but in practice the sites will not all initially be occupied, for example only 50% may be occupied. This occupation may be in a non-ordered or random manner. As such a sub register may be formed from the initial register by determining which sites are occupied and then using the tweezer light beam to move atoms from one site to another so that at least one set of two or more trapping sites are occupied according to a predetermine arrangement, for example a 3D periodic grid of atom-occupied sites. Each site in the sub register holds a single atom, hence has unit filling. This may be referred to as being a defect-free sub-register, wherein a defect is a site in the sub-register that is intended to be filled but is not, or conversely, a site that is intended to be unfilled but is filled. Other sub register atom arrangements are also possible.

To determine where the atoms are initially held in the register, the atoms are imaged by collecting their fluorescence signals by a camera 866. From these one or more images a program run on a classical computer system may be used to determine the position of the initially occupied sites 858. Additionally, or alternatively a user may provide input to determine such positions. When a classical computer is used, an algorithm is used to determine a set of moves, for the tweezers, to rearrange the initial configuration to the desired predetermined configuration. The algorithm may be run on a computer comprising an GPU to affect real time processing. A Field Programmable Gate Array (FPGA) may be used to transfer the data in this operation. The data that corresponds to the required ‘moves’ is then communication to the 2D acousto-optic laser beam deflectors 848.

Optionally, a further image may be acquired in a similar way as described above to check whether the sub-register formed has atoms in the predetermined positions. Furthermore, when the quantum processing is complete, the sub-register may be read out in a similar way using camera 866.

The sub-register of atoms described above that is operated on to perform quantum computing operations may be referred to as the ‘register’. Furthermore, it is to be understood that any quantum operations made on the register, according to a desired quantum algorithm, may be repeated one or more times to reconstruct the relevant statistical properties of the final quantum state produced. This is typically done because of the probabilistic nature of each possible outcome imposed by quantum mechanics.

As described above, the quantum states of the atoms may be controlled by atomic state actuators. Typically, these atomic state actuators may be implemented as lasers, however other actuators may be used. As will be described hereunder in more detail, the quantum processor may be used for analog computing where laser signals are applied to the atoms to realise a Hamiltonian. The quantum processor may also be used for digital computing wherein a quantum algorithm is decomposed into a plurality of quantum logic gates, which are executed successively in time. The quantum gates are realised by exposing individual atoms in the register with predetermined laser pulse signals.

The two qubit states that may be used are the hyperfine ground states of an atom, such as a rubidium atom. Hyperfine states of other atoms may be used in the alternative. These ground states have long or infinite lifetimes that prevent radiative coupling to the electromagnetic environment. This is advantageous because digital quantum computing requires qubits that are robust against decoherence. The spacing between atoms in the register may be several micrometres. The laser used for transitioning the atoms between these two hyperfine ground states may be a Raman laser. This laser and its output light may be referred to herein as the ‘Raman channel’. The quantum processor may use a plurality of Raman channels to address different atoms.

Quantum logic gates may be implemented by operating on a single qubit or operating on multiple qubits, such as two or more qubits. A single qubit gate may be implemented by having a laser act upon the atom wherein any single qubit gate may be implemented by tuning the properties of the incoming laser signal. This laser signal may also be referred to as a ‘control field’. By changing the properties of the control field, any arbitrary rotation of the qubit state, on the Bloch sphere, may be performed. The atom-laser field interaction is affected by the Rabi frequency Ω (which proportional to the amplitude of the laser field); the detuning δ (the difference between the qubit resonance and the field frequencies) and their relative phase. Driving the control field for a duration t induces rotations around the (x, y, z) axes. Hence, any single-qubit gate can be implemented by tuning the pulse duration, the laser intensity, and detuning and the phase of the laser.

Thus, the transitions between atomic states, hence quantum states, of the atomic system, may be controlled by the transmission of electromagnetic control pulses by one or more electromagnetic sources. A control pulse may be defined as the modulation of a channel's output amplitude, detuning, and phase over a finite duration t. For a channel targeting the transition between energy levels a and b, with resonance frequency ω_{ab}=|Eₐ−E_{b}|/h, the output amplitude determines the Rabi frequency Ω(t), and the detuning δ(t), is defined relatively to ω_{ab} and the frequency of the channel's output signal ω(t), as δ(t)=ω(t)−ω_{ab}. Additionally, the phase φ of a pulse can be set to an arbitrary, constant value. A pulse-driven transition between two energy levels can be mapped to a spin-½ system through the drive Hamiltonian (equation 31):

$${H}^{D} ( t ) = \frac{ℏ}{2} Ω ( t ) \cdot σ ,$$

where σ=(σ^{x}, σ^{y}, σ^{z})^{T} is the Pauli vector and Ω(t)=(Ω(t) cos(φ),−Ω(t) sin(φ), −δ(t))^{T} the rotation vector. As shown in FIG. 9, in the Bloch sphere representation, for each instant t, this Hamiltonian may be described by a rotation around the axis Ω with angular velocity (equation 32):

$${Ω}_{EFF} = \vert Ω \vert = \sqrt{{Ω}^{2} + {δ}^{2}}$$

The above parameters for driving the control field may be controlled using direct digital synthesizers (DDS) that drive acousto-optic modulators (AOMs) and/or electro-optic modulators (EOM) placed on the laser beams or other electromagnetic sources. As an illustration, when driving the control field at resonance (δ=0), the qubit oscillates in time between the states |0 [symbol] and |1 [symbol] .

One-qubit gates are specific unitary transformations described by 2-by-2 complex matrices transforming one qubit state into another. Notable examples are the NOT-gate that changes the state |0 [symbol] into |1 [symbol] and vice-versa. Similarly, the Hadamard H gate is another single-qubit gate that generates superposition of both states starting from a pure state. The NOT gate may be implemented by a π rotation about the x axis in the Bloch sphere whilst the Hadamard gate may be implemented by a π rotation about the (x+z) axis.

Two-qubit gates are unitary transformations described by 4-by-4 matrices that transform one two-qubit state into another, allowing the generation of entanglement in the register. From a physics viewpoint, their implementation requires an interaction between the qubits. However, neutral atoms in their electronic ground state can only interact significantly via contact physical collisions. Single atoms are typically separated by a few micrometres in the register and therefore do not naturally ‘feel’ each other, therefore they do not normally interact. Two or more qubit gates described herein may cause different qubits to interact using Rydberg states, in particular by the Rydberg blockade. An atom in a Rydberg state or a ‘Rydberg atom’ is an excited atom with one or more electrons that have a very high principal quantum number n entailing that the electron is far from the nucleus and thus allows that atom to interact with another atom. The laser signal used to impart light at the wavelength need for the Rydberg transition may be referred to as the Rydberg laser. The Rydberg laser and its output light may be referred to herein as the ‘Rydberg channel’.

FIG. 10A-10D depict implementations of quantum spin models with neutral atoms. FIG. 3A-3C schematically show three levels of the atomic system of the rubidium atoms used herein wherein: the energy levels ‘g’ and ‘h’ denote the hyperfine states that represent the |0 [symbol] and |1 [symbol] qubit states respectively, whilst ‘R’ represents the Rydberg state of the atomic system and is associated with quantum state |r [symbol] . The label of ‘π’ in FIGS. 10A and 10B is shown when a single transition is made between the g and R state indicating that a π phase change has been imparted into the atomic system because of the overall transition.

When a laser field of sufficient duration and amplitude has been imparted onto the atom to resonantly transition it from the g energy level up to the R energy level and then back to the g energy level (within the same control field input), this is labelled as ‘2π’ indicating that a 2π phase change has been imparted into the atomic system because of the overall transition. The laser fields that give rise to these π and 2π transitions may be respectively referred to as a π-pulse and a 2π-pulse. It is understood that the input control fields causing these transitions have a wavelength resonant with the |0 [symbol] to |r [symbol] transition and not resonant between the |0 [symbol] and |1 [symbol] transition. FIG. 10A shows the atomic transition from the g level to the R level with a π-pulse. FIG. 10B shows the atomic transition from the R level to the g level with a π-pulse. FIG. 10C shows the atomic transition from the g level to the R level and back to the g level again with a 2π-pulse.

FIG. 10D depicts a near-resonant laser pulse of amplitude Ω exposing an atom. The frequency of the laser pulse is detuned from the transition frequency between the ground state |g [symbol] and a Rydberg state |r [symbol] by a small (with respect to the transition frequency) detuning δ. The amplitude Ω of the pumping laser determines the transverse-field term in the Ising model, and the detuning to resonance δ induces a longitudinal-field term. Additionally, the global phase of the laser can be tuned in order to control the axis of rotation on the Bloch sphere induced by the transverse-field term. The pulse depicted in FIG. 10D represents a single gate operation defining a predetermined rotation over the Block sphere.

As already described above, interaction between two or more qubits may be realised when the atoms are in the Rydberg states. In such situations, certain transitions may be blocked due to the so-called Rydberg blockade. The Rydberg blockade may be used to implement digital gate operations such as the Controlled-Z (CZ) gate using the atomic system of the quantum processor. An CZ gate may be used with two Hadamard (H) gates, one each side of the CZ gate, to form a so-called CNOT gate, which is an important gate in quantum computing because it may be shown that any quantum algorithm may be implemented by combinations CNOT gates and/or single qubit operations changing the qubit state to any arbitrary state around the Bloch sphere.

Typically, quantum algorithms, such as the DQC quantum algorithm, requires execution of ‘digital’ quantum circuits comprising large blocks of single and multi-gate operations, for example multiple rotation operations and CNOT gates, require multiple pulse signals, each comprising long sequences of pulses, to control individual qubits. The longer the sequence of pulses, the higher the likelihood that the atomic system providing the quantum computing regime decoheres and the ability to perform the full set of quantum computation processes collapses. Besides the length of the pulse signals, these pulse signals need to be controlled fast and accurately so that multiple atoms can be addressed in time. To date, such optical control circuits are difficult to realize, thus limiting the use of many algorithms which were originally designed as digital-gates algorithms, such as DQC.

The embodiments in this application address this problem by using digital operations, in particular singe digital qubit operations, in combination with analog operations, i.e. the natural evolution of the interacting neutral atom system, for the entangling operations between multiple qubits. In particular, the embodiments in this application propose execution of complex quantum circuits, such as DQC quantum circuits, based on single digital gate operations and, optionally, simple multiple qubit operations, in combination with analog circuit blocks for entanglement operations between many qubits. This way, complex quantum circuits representing advanced quantum computations, such as DQC, can be executed on current neutral atom quantum processors without requiring the need to execute complex and lengthy blocks of ‘digital’ entanglement operations. In an embodiment, to realize such scheme, one can work with one ground state and one Rydberg state as the |0 [symbol] and |1 [symbol] levels of the qubits. Two atoms put in a Rydberg state at the same time will experience a strong dipole-dipole interaction of rather long range (a few micrometre). When subject to a drive by a laser system, the dynamics of the ensemble of atoms is governed a Hamiltonian for Rydberg system of neutral atoms (equation 33):

$$H ( t ) = \frac{h}{2} Ω ( t ) {\sum }_{j} {σ}_{j}^{x} - h δ ( t ) {\sum }_{j} {n}_{j} - {\sum }_{i \neq j} \frac{{c}_{6}}{{r}_{ij}^{6}} {n}_{i} {n}_{j}$$

with nⱼ=(1+σⱼ^{x})/2 being the Rydberg state occupancy and σⱼ^{x,y} the Pauli matrices of the spin j. The first two terms of the Hamiltonian define a first part of the Hamiltonian which can be controlled by the laser that couples to the qubit states and relate to an effective magnetic field, with transverse and longitudinal components B_{⊥∝Ω(}t) and B_{∥}∝−δ(t). This way the first part of the Hamiltonian can be controlled by the intensity and the frequency of the laser field in a way as explained with reference to FIG. 10D. The second part of the Hamiltonian relates to the interactions between individual spins of the atoms. More specifically, it corresponds to an energy penalty that two qubits experience if they are both in the Rydberg state at the same time. The coupling between two spins of atoms i and j of the register is of van der Waals type and depends on the inverse of the distance rᵢⱼ between these two atoms to the power of 6, wherein Ce is a coefficient relating to the Rydberg state. Hence, this part of the Hamiltonian can be controlled by controlling the distance between the atoms in the register.

Hence, in an embodiment, atoms may be put in a Rydberg state at the same time so that they experience a strong dipole-dipole interaction of rather long range (a few micrometres) and then different single individual qubit operations may be applied to the atoms. This way analog-digital quantum circuits may be executed on a neutral atom processor. The advantages of such analog-digital quantum circuits will be described hereunder in more detail. Further, the inventors found out that these analog-digital quantum circuits are differentiable, so that these circuits can be used in a DQC scheme for solving differential equations using a neutral atom quantum processor.

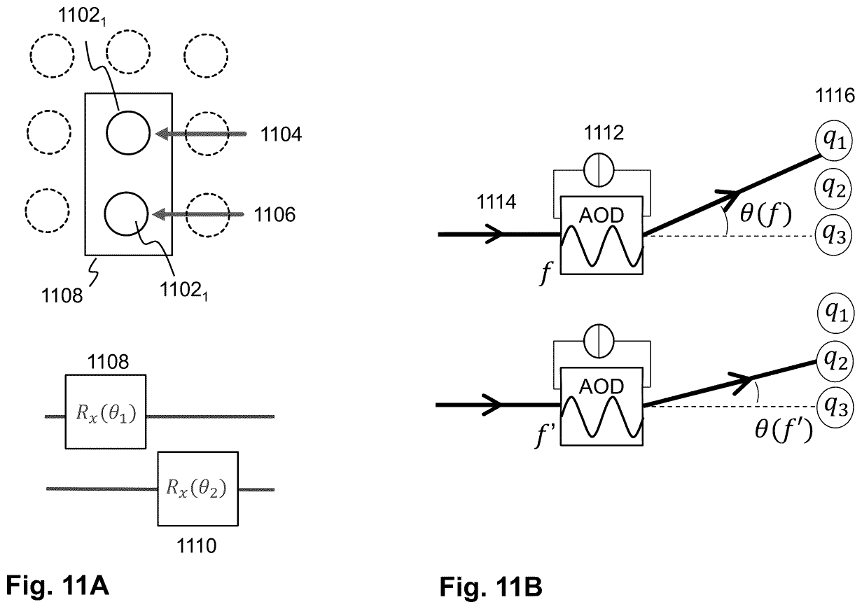

FIGS. 11A and 11B illustrate a scheme for executing single qubit operations on a neutral atom processor. As shown in FIG. 11A, laser fields of laser beams, a first laser beam 1104 and a second laser beam 1106, may be focalized using optical elements on an active area 1108 such that the first laser beam can address the first neural atom 11021 and the second laser beam can address the second neutral atom 11022. The characteristic length scale of the obtained focalized beam is typically sub micrometer, which enables the selective addressing of one given atom in the atomic array. As shown in FIG. 11B, control over laser beams can be achieved with an acousto-optics deflector (AOD) 1112, wherein the laser beam 1114 deflects over a certain angle as a function of the AOD frequency. This is a known addressing technique in neutral atom processors to address neutral atoms when executing a quantum circuit (see for example the article by Graham et al. https://arxiv.org/pdf/2112.14589.pdf). By changing focal point of the laser beam with the AOD, successive single qubit gates can be applied to distinct qubits in the array, as illustrated in the figure. The re-targeting time of the AOD is of the order of tens of nanoseconds. Based on this technique successive single qubit operations can be executed including a first rotation operation 1108 over an angle θ₁ and a second rotation operation 1110 over an angle θ₂. While the figure illustrates the application of successive qubit operations on two atoms, this scheme can be applied to any desired configuration of atoms.

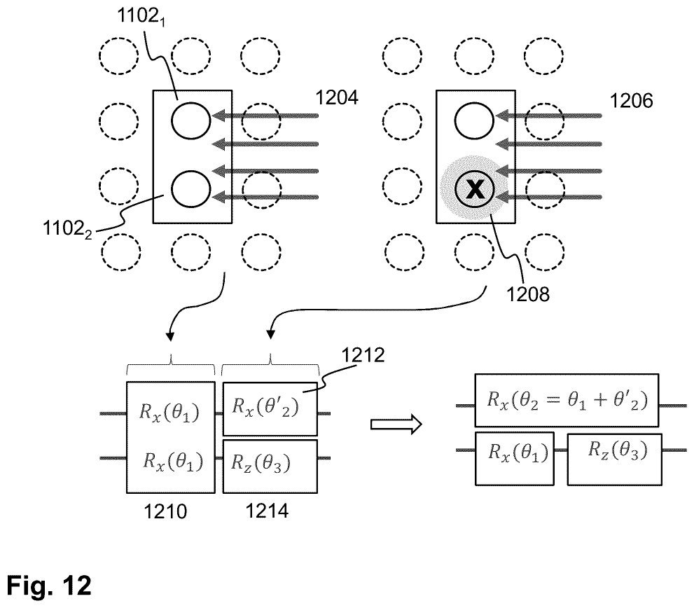

FIG. 12 depicts a further scheme for executing single qubit operations on atoms of a neutral atom processor. In this embodiment, a laser beam shining on a Spatial Light Modulator (SLM) may be used to generate one laser spot that is positioned on an atom or atoms that one does not want to address. This laser light will shift the targeted atom(s) off-resonance, thereby effectively masking the atom so that it is not affected by subsequent resonant laser pulses. The “mask” can be switched on/off in a few tens of nanoseconds. Thus, a global laser field 1204 may be used to expose a plurality of atoms, for example first atom 12021 and second atom 12022, as shown in the figure, while the mask 1208 may be switched on during the exposure of the atoms thereby allowing the application of individually tunable single-qubit gates angles. It is clear that this pulse scheme for executing single qubit operations may be used with multiple qubits for example a first pulse may be used to expose 10 atoms and a second pulse may be applied to the 10 atoms while 5 atoms are selectively masked by using laser pulses that are generated using the SLM. The typical re-targeting time of an SLM is rather slow (from a few Hz to kHz) but the on/off time of the mask can be very fast.

As shown by the quantum circuit, the first laser pulse will case a first rotation operation 1210 over an angle θ₁ for both atoms. When the mask 1208 is turned on, the first atom will continue to receive laser light representing a further rotational operation 1212 over an angle θ₂. Additionally, the light of the laser originating from the SLM may have an effect based on the type of targeted atom. This may induce an additional rotation θ₃ 1214 along the z-axis, wherein the angle depends on the amplitude of the light-shift and the duration of the masking period.

The proposed use of single gate operations in combination with analog multi-qubit entanglement operations may be used to execute a DQC type quantum circuit including one or more variational maps and at least one variational ansatz.

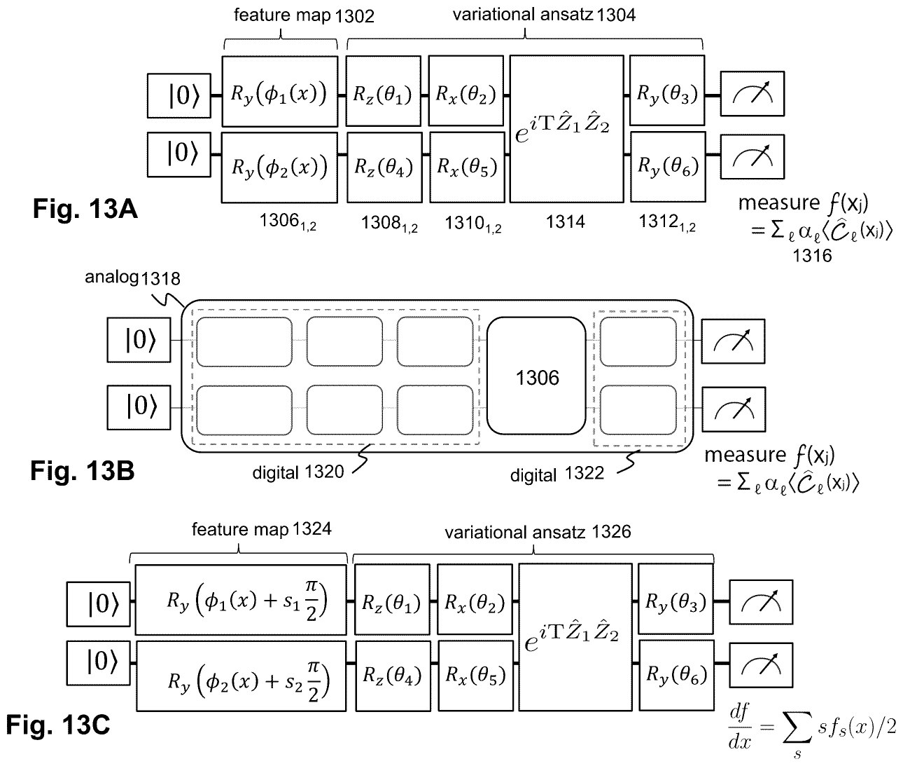

FIG. 13A-13C show examples of quantum circuit for a neutral atom quantum processor according to various embodiments. In these embodiments, the analog evaluation may be realized by a (relatively weak) interaction that is on throughout the execution of the whole quantum circuit, while the single qubit gates are implemented as short digital gates. As shown in the figure, the quantum circuit may include (combinations of) single digital qubit gates Rₓ, R_{y}, and R_{z}, interleaved with an analog multi-qubit operation, e.g. a two-qubit operation involving entanglement of two neutral atom qubits, that evolves the system over a Hamiltonian associated with the neutral atom qubit register. For example, the Hamiltonian may be a Hamiltonian for a Rydberg system of neutral atoms, for example one such as the one associated with an ensemble of neutral atoms (a quantum register of neutral atoms) as provided above by equation 33. This circuit can be used to learn a trial function ƒ(x) for different points xⱼ in the variable space of the function.

As shown in the figure, the quantum circuit may include at least a quantum feature map 1302 and a variational ansatz 1304. Here, the quantum feature map may include single-qubit gates, for example single qubit gates representing a rotation R_{y} which depend (non-)linearly on the input variable x via functions ϕ₁ (x) and ϕ₂(x) 1306_{1,2}. Further, the variational ansatz may comprise single qubit operations, such as single qubit rotations Rₓ 1310_{1,2}, R_{y} 1312_{1,2}, and R_{z} 1308_{1,2} which depend on variational parameters θ₁₋₆ which can be optimized in a variational optimization schedule as described with reference to FIGS. 6A and 6B. In addition to the single qubit “digital” rotation operations, the variational ansatz may also include an analog gate operation, i.e. an entanglement operation 1310 representing an evolution of a Hamiltonian, for example the ZZ Hamiltonian, in time. The final measurements are performed in the Z-basis. A trial function ƒ(xⱼ) 1316 may be computed as a potential solution to the differential equation, wherein in this case the trial function is a sum over operators [symbol] (in a similar way as described with reference to FIG. 2A). In this example [symbol] =(1,2) and C=Z and α₁=α₂=1.

FIG. 13B depicts a general layout of a digital analog quantum circuit representing (weakly) interacting atomic qubits that interact via the evolution of a Hamiltonian associated with the neutral atom register in time and thus may be represented as one big analog block 1318. Then, during the evaluation of the Hamiltonian, fast single digital gate operations 1304, 1308, such as single qubit rotations, may be executed and—if one or more entanglement operations are required—one or more analog blocks 1308 may be executed, wherein the analog blog represents the evolution of the Hamiltonian over time. Thus, instead of executing a quantum circuit block comprising a plurality of complex two of multi-qubit gate operations, an analog gate operation is executed when an entanglement operation involving the two or multiple qubits is needed. This is way, the problem of addressing multiple atoms in the register to achieve complex digital two- and multi-qubit operations can be avoided and quantum circuits can be efficiently executed on a neutral atom computer as a set of single gate operations and one or more analog gate operations.

The digital-analog quantum circuits for the neutral atom quantum processor as described with the embodiments in this application may be used for xxx in a general DQC scheme as described above with reference to FIG. 1-6 above. Using the DQC scheme for solving differential equations, it is necessary that the quantum circuit that includes one or more analog blocks is differentiable. Kyriienko et al, showed in their article Generalized quantum circuit differential rules, Phys. Rev. A 104, 052417 (2021), how unitary operations constructed from general generators Ĝ can be differentiated with respect to the ‘evolution time’ φ(x) based on the following derivation (equations 34a-34d):

$$\hat{U} ( x ) = exp ( - i \frac{φ ( x )}{2} \hat{G} )$$

$$\frac{df ( x )}{dx} = \frac{i}{2} 〈 {ψ}_{\overline{θ}} \vert \text{?} [ \hat{G} , {\hat{𝒞}}_{\overline{θ}} ] \text{?} \vert {ψ}_{\overline{θ}} 〉$$

$$\text{?} \hat{G} {\hat{𝒰}}_{G} = {\sum }_{j} {λ}_{j} {\hat{𝒫}}_{j} \text{=:} \hat{D}$$

$$\frac{df ( x )}{dx} = \frac{d}{dx} 〈 {ψ}_{\overline{θ}} \vert ( \text{?} {\hat{𝒫}}_{j} ) {\hat{𝒞}}_{\overline{θ}} ( \text{?} ) \vert {ψ}_{\overline{θ}} 〉 = \frac{i}{2} \text{?} ( {λ}_{j} - {λ}_{{j}^{′}} ) \text{?} 〈 {ψ}_{\overline{θ}} \vert {\hat{𝒫}}_{j} {\hat{𝒞}}_{\overline{θ}} \text{?} \vert {ψ}_{\overline{θ}} 〉 ,$$

$$\text{?} \text{indicates text missing or illegible when filed}$$

Classical calculations of the spectral gaps are needed to compute necessary parameter shift rules. Such calculations are very simple for generators produced by a single string of Pauli operators, as there is only a single degenerate spectral gap. For sums of Pauli strings however, such as those used in typical analog blocks/Hamiltonians, this number grows with the number of distinct gaps in the spectrum. For large random Hamiltonian generators, this poses an insurmountable problem, while for non-random, however inventors found out that for structured Hamiltonians such rules can actually be found efficiently. This is the case for the Rydberg Ising-Hamiltonian (equation 33 above), which has equal n-n interaction strengths between neighboring pairs of atoms. Such structure allows for specific analytical differentiation rules to be constructed. The implications for the digital-analog quantum circuits as described with reference to the embodiments in this application can then be summarized as follows;

1. Variational ansatze, parameterized by variational parameters, may comprise one or more analog blocks and can be differentiated analytically for gradient-descent purposes;

2. Quantum feature maps can be constructed based on one or more analog blocks with evolution times proportional to the input variable x, and can then be differentiated analytically with respect to the feature variables;

Thus, the digital-analog quantum circuits for a neutral atom register can be differentiated analytically so that they can be used in variational and/or quantum machine learning schemes, including the DQC scheme as described previously. FIG. 13C depicts an example of analytically differentiated analog-digital quantum circuit. The circuit is based on the circuit as illustrated in FIG. 13A, but now the quantum feature map is differentiated so that it can be used to compute the derivative of the function ƒ with respect to x, using derivative quantum circuits, and evaluated at x=xⱼ. The differentiation operations introduce a parametric shift of variables in the unitary. The derivative of the sought function ƒ(x) evaluated at specific point x=xⱼ may be estimated as a sum of expectation values for derivative quantum circuits in a similar way as explained with reference to FIG. 2B.

As shown in the figure, the rotation angles in gates of the feature map 1324 are shifted by s₁ and s₂ respectively, while the digital circuits and the analog circuits of the variational ansatz 1326 are identical to the one in FIG. 13A. Circuits of this form can be used to evaluate derivatives of the circuit output with respect to input variable x, using the parameter shift rule. For that, the sum over for circuits may be computed, where these combinations of (s₁,s₂) are used: (s₁,s₂)=[(+1,0), (−1,0), (0, +1), (0,−1)], and each time all other variables have the same value. Every time s₁ or s₂ is negative, the result is subtracted instead of added. For all terms with s₁, the result is also multiplied by the derivative of ϕ₁(x) with respect to x, and for all terms with s₂ shifts, they are multiplied by the derivative of ϕ₂ (x) with respect to x. The parameter shift rule is also applicable in FIG. 13C when the digital gates are executed much faster than the analog block in terms of interaction strength. It is submitted that the quantum circuits depicted in FIG. 13A-13C are just few of the many circuits that are possible according the teaching of the different embodiments. For example, in an embodiment, the quantum circuit may include multiple qubits (more than two). In an embodiment, the quantum circuit may include a feature map including single digital operations and one or more analog gate operations (one or more analog blocks). Similarly, in a further embodiment, the variational ansatz may include single digital operations and one or more analog gate operations. Additionally, in yet another embodiment, the feature map and/or variational ansatz may be implemented as a single analog block.

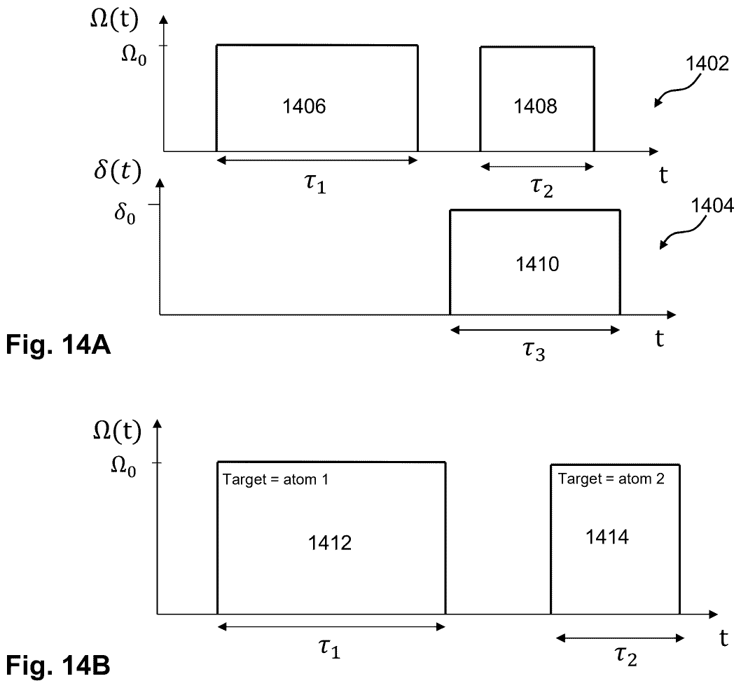

FIGS. 14A and 14B show pulse diagrams for executing digital-analog quantum circuits on a neutral atom qubit register according to an embodiment of the invention. In particular, FIG. 14A illustrates a pulse diagram associated with a quantum circuit as described with reference to FIG. 13A-13C, wherein the addressing is realized using a masking technique with a SLM as described with reference to FIG. 12. The first diagram 1402 shows a first pulse signal 1406 of duration τ₁ and a second pulse signal 1408 of duration τ₂ of a global laser which is resonance with the qubit transition of a first and second atom as a function of time. The durations τ₁ and τ₂ and amplitude Ω₀, of the first and second pulse are selected so that a first angle θ₁=τ₁×Ω₀, represents the rotation induced by the laser field in the first atom and second angle θ′₂=τ₂×Ω₀ represents the rotation in the second atom wherein the angles variables θ₁ and θ′₂ are those described in FIG. 12. The second diagram 1404 shows a further third laser pulse 1410 of duration τ₃ for selectively addressing, in this case “masking’, the second atom during the time period that the first and second atoms are exposed to the second pulse 1408. This third strong laser pulse that is focalized on the second atom causes a light-shift on the second atom. The light pulse that has a large amplitude δ₀ (substantially larger than Ω₀ i.e. typically one order of magnitude or more) is selectively applied to the second atom. Due to this light pulse, the second pulse (of duration τ₂) is no longer on resonance with the g-R transition for the second atom, and has no effect on the second atom. The net effect of the light shift on the second atom is that of a Z-gate (rotation along the z axis) of angle θ₃=τ₃×Ω₀, as explained with reference to FIG. 12.

FIG. 14B illustrates a pulse diagram associated with a quantum circuit as described with reference to FIG. 13A-13C, wherein the addressing is realized using a using AOD(s) as described with reference to FIGS. 11A and 11B. The diagram shows the amplitude of a local laser that is on resonance with the qubit transition of a first atom and a second atom as a function of time. The durations τ₁ and τ₂ and amplitude Ω₀ of the first and second pulse are selected so that a first angle θ₁=τ₁×Ω₀ represents the rotation induced by the laser field in the first atom and second angle θ′₂=τ₂×Ω₀, represents the rotation in the second atom wherein the angles variables θ₁ and θ′₂ are those described in FIG. 12, wherein the angles variables θ₁ and θ′₂ are those described with reference to FIGS. 11A and 11B. Here, the AOD is used to target the first pulse to the first atom with the AOD and the second pulse to the second atom.

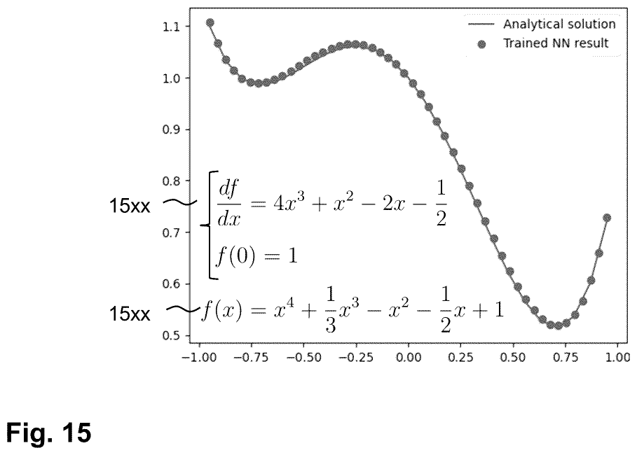

FIG. 15 shows a graph representing the solution of a differential equation 1502 that has been solved using the quantum circuits for a neutral atom quantum processor as described with reference to FIG. 13A-13C. The solution has been determined on the basis of differentiable quantum circuits and the DQC scheme as described with reference to FIGS. 6A and 6B. For this simulation, a classical computer is used to simulate the output of the quantum circuits (represented by the dots in the graph), which is still feasible at this small scale of two qubits. It has been found that when no analog entangling block is used, the solution cannot converge, while if an analog entangling block with T=1.0 is used, it converges to the correct analytical solution 1504. The differential problem has been tailored such that the solution is a sum of independent-coefficient polynomials in x up to order 4, so x⁴, x³, x⁴², x¹ and a constant shift. The constant shift can be classically implemented, but the other four terms can only be independently fitted by gaining access to the 4-dimensional feature space. This is possible due to the entanglement between two qubits granting access to the enlarged Hilbert space. For the training, a two-staged approach is used wherein for the first 80 epochs an ADAM optimizer with learning rate 0.5 was used, followed by a BFGS optimizer for 20 epochs with learning rate 0.05.

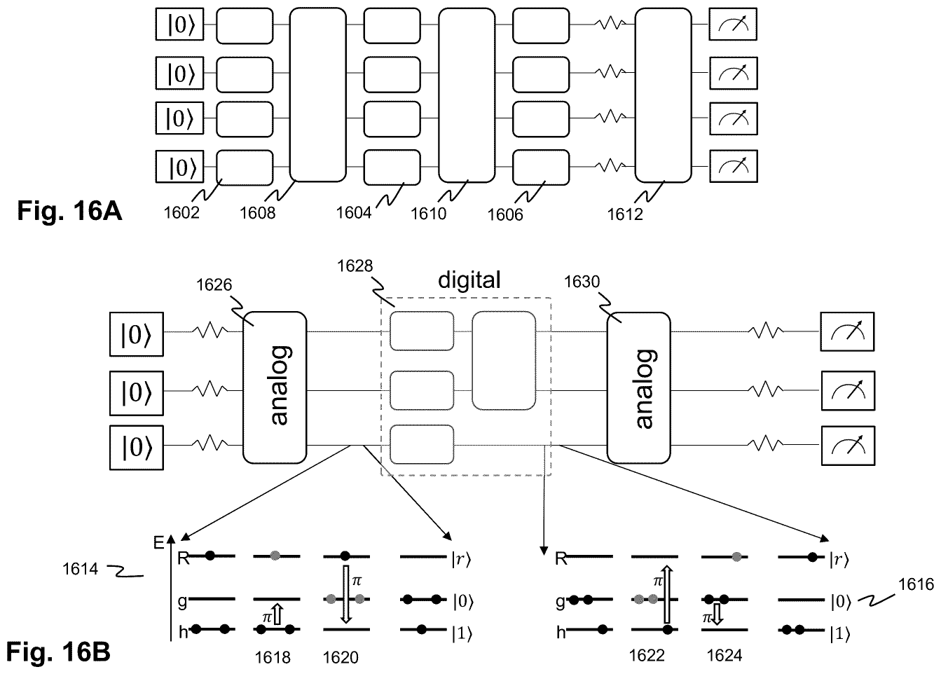

FIGS. 16A and 16B illustrate an example of quantum circuit for a neutral atom quantum processor according to another embodiment of the invention. In this particular, case use if made of the three levels in a neural atom: hyperfine (h), ground (g) and Rydberg (R). Based on these levels digital gate operations 1602, 1604, 1606 can be combined with analog gate operations 1608, 1610, 1612. Here, the analog evolution is restricted to the {|1 [symbol] , |r [symbol] } basis, while the digital (gate based) computations are done in the {|0 [symbol] , |1 [symbol] } basis. When moving from an analog bock 1626 to a digital block 1628, one moves from the analog basis to the digital basis by two i pulses: the first π pulse 1618 which maps |1 [symbol] into |0>, while the second π pulse 1620 maps then |r [symbol] into |1 [symbol] . When moving from a digital bock 1628 to an analog block 1630, one moves from the digital basis to the analog basis by two π pulses: the first π pulse 1622 which maps |1 [symbol] into |r [symbol] , while the second π pulse 1624 maps then |0 [symbol] into |1 [symbol] . This embodiment differs from the one described with reference to FIG. 13 in the sense that in this embodiment, the execution of the digital gates is separate from the analog gates, while in the embodiment of FIG. 13 the digital gates are executed “on top” of an analog evolution of the Hamiltonian. This embodiment has the advantage that the lifetime of the Rydberg state is lower than the lifetime of the hyperfine states. Thus, as the system is most time executed based on the hyperfine states, in this embodiment, more digital and/or analog blocks can be executed by the quantum processor. Additionally, as the gates are separated from the analog blocks, the constraints with regard to their duration (execution time) is relaxed. The atoms can be controlled with optical pulses that require less power (as it is not necessary to overcome the interactions between the atoms). This way the pulses can be more controlled, leading to higher fidelity gates.

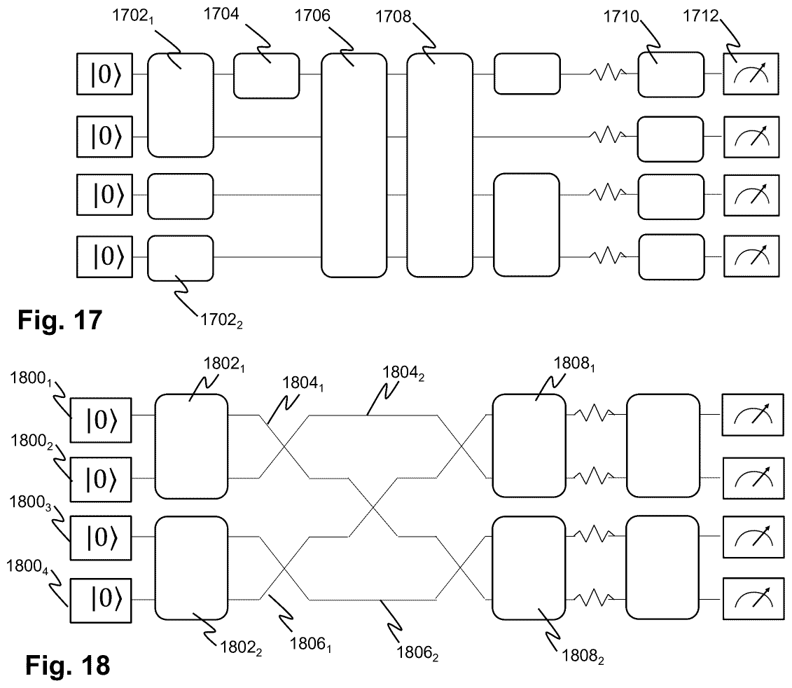

FIG. 17 illustrates an example of quantum circuit for a neutral atom quantum processor according to another embodiment of the invention. In this embodiment, two- or multi-qubit digital gates 1702₁ may be used, alongside single-qubit gates 1702₂. Hence, not all gates may be using analogs blocks 1706, 1708, and therefore executed sequentially in time instead of in parallel. Both the single-qubit or multi-qubit operations may be either of digital or analog type. At the end of the circuit execution, basis rotation sub-circuit, include single-qubit rotations 1710, are applied before measurement 1712 of the qubits in their Z-basis, in order to effectively measure qubits in other bases, including X, Y, or multi-Pauli bases.

FIG. 18 illustrates an example of quantum circuit for of a neutral atom quantum computer according to a further embodiment of the invention. In particular, the figure illustrates a quantum circuit executed on a reconfigurable atomic lattice, wherein each atom represents a qubit 1802₁₋₄. Interactions can often only be performed between qubits which physically are close to each other. Examples in this figure include two-qubit gates 1802_{1,2} which provide entablements between neighboring qubits: first two-qubit gate 1802₁ operates on neighboring qubits 1802_{1,2} and second two-qubit gate 1802₁ operates on neighboring qubits 1802_{3,4}, wherein qubits 1802_{1,2} and qubits 1802_{3,4} are non-neighboring, i.e. spatially distant from each other so that they cannot interact. In order to bring “distant” qubits in the register towards each other, the positions 1804_{1,2} 1805_{1,2} of the physical atoms representing the qubits can be moved around in order to bring qubits into each other's neighborhood for novel interaction purposes 1808_{1,2}: e.g. two-qubit gate operation 1808_{1,2} between the second qubit and the forth qubit and two-qubit gate operation 1808_{3,4} between the first qubit and the third qubit. Hence, between subsequent entanglement operations the position of the qubits may be re-arranged. This process may be repeated until all qubits have been neighbors at least once, so that all qubits are entangled.

Executing quantum gate operations of analog-digital quantum circuits as described with reference to the embodiments in this application requires accurate, fast and scalable optical addressing of the trapped qubits. Optical addressing may be realized by AOD-based controlling of laser beams as described above with reference to FIG. 11B above. However, laser beams controlled based on AODs only provide a limited bandwidth. Moreover, optically addressing qubits based on arbitrarily qubit illumination patterns is difficult using AODs. Techniques enabling the use of arbitrarily qubit illumination patterns to optically address qubits, such as liquid-crystal based spatial light modulators (SLMs), are however limited by the bandwidth of the liquid-crystal based SLM.

When executing large and complex quantum circuits, including analog-digital quantum circuits, on an atomic qubit quantum computer, fast optical addressing schemes are needed that allow accurate optical manipulation of individual qubits in the qubit array based on arbitrary illumination patterns. Here, the optical manipulation of individual qubits includes execution of single qubit operations, two-qubit operation and/or multi-qubit operations, wherein the two- or multi-qubit operations require interaction between the qubits. Interaction may for example occur when qubits in the Rydberg state are close to each other, e.g. neighboring qubits. The qubit operations need to be executed within the coherence time of the states of the qubits. As the coherence time of the quantum states are still rather short, execution of qubit operations needs to be performed in a fast and efficient way. Here, efficient execution may include executing qubits operations simultaneously (in parallel) in different parts of the qubit array.

To address these challenges, embodiments are provided for optically addressing qubits in a qubit array based on spatio-temporally structured light to enable fast execution of digital-analog quantum circuits on a. Temporal structured light based on polarization may be used to enable alternating exposure of two or more computer-controlled micromirror devices, e.g. one or more DMDs, by a spatially structured light beam. The micromirror devices may reflect part of the spatially structured light towards the qubit array so it can be used fast and efficient address multiple individual qubits. The spatial modulation gives a spatial structure to the light beam so that it has a 2D grid-like intensity profile that matches the gird of micromirrors of the micromirror devices and the grid of qubits so that each of a plurality of light beams can be focused onto an individual qubit, without affecting neighboring qubits. Further, the addressing scheme is based on simple illumination patterns, which allow any type of addressing, without complex encoding schemes.

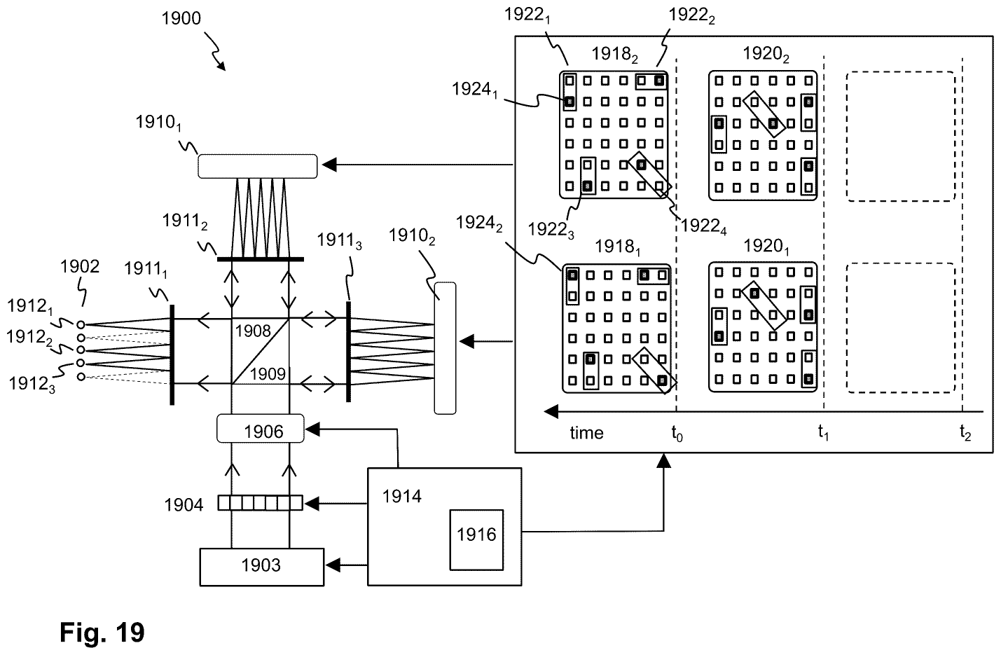

FIG. 19 illustrates a system for optically addressing qubits of a qubit array according to an embodiment. Such system may be used to execute analog-digital quantum circuits as described with reference to the embodiments in this application. In particular, the figure illustrates an arrangement of qubits 1902, e.g. a 2D qubit array, wherein an optical addressing module is configured to optically address qubits by projecting focused light beams onto individual qubits of the qubit array. As shown in the figure, the optical addressing module may include a laser system 1903, which is optically aligned with a spatial modulator 1904, for example a spatial light modulator (SLM) for spatially modulating a light field, a temporal light modulator 1906, e.g. electro-optic modulator (EOM) for temporally modulating a light field based on polarization or phase, an optical splitter 1908 for splitting a temporally modulated light beam based on the temporally modulated optical property such as polarization or phase. The optical splitter may be optically aligned with at least two micromirror devices 1910_{1,2}, such as a digital micromirror device (DMD) and the qubit array.

The micromirror devices may be configured as reflective SLMs that are based on arrays of addressable micromirrors. These SLM are typically referred to as digital micromirror devices (DMDs). DMDs comprise micro-scale mirrors which can deflected to redirect incident light towards a target (“on”) or away from a target (“off”). The micromirrors may be controlled in a binary way, i.e. either “on” of “off”. This way, small light beams can be directed towards and focussed onto individual qubits in the qubit array. DMDs have high switching times (in the order of tens of microseconds) and are thus suitable for fast optical addressing of qubits.

The one or more spatial light modulators for generating the spatio-temporally structured light beam may be based on a Liquid-Crystal type SLM, such as liquid-crystal on silicon (LCOS). Such SLM may be configured as a transmissive or a reflective SLM. The pixels of these SLM may have many different settings to control the phase and/or amplitude of light. In contrast to DMDs, LC-based SLMs are rather slow (in the order of 100 Hz).

Optical elements 1911_{1,2}, refractive and/or diffractive optical elements, may be used to focus spatially modulated light beam originating from the laser source as a plurality of focused light beams onto the micromirror devices. Spatially modulated light originating from the micromirror devices may be relayed via an optical relay element 1909 towards the qubit array. One or more further optical elements 1911₃, refractive and/or diffractive optical elements, may be used to focus the spatially modulated light originating from the micromirror devices into a plurality of light beams, wherein each of the plurality of light beams is focused onto a qubit in the qubit array.

The optical addressing module may be controlled by a computer 1912. The micromirrors of the reflective SLMs may be controlled by the computer according to addressing information that identifies different qubits in the qubit array that need to be optically addressed at different time instances. The addressing information may be in the form of different illumination patterns wherein each illumination pattern represents information (in any data format) that identifies qubits in the qubit array that need to be optically addressed at a given time instance. For example, in the figure a plurality of focused light beams is generated wherein each focused light beam addresses a qubit 1912₁₋₃. The beam profile, i.e. the cross sectional intensity profile, of a focused light beam that is used to optically address a qubit may be configured for qubit addressing such that only the addressed qubit interacts (is exposed to) with the light of the focused light beam, while other qubits, e.g. neighboring qubits, are not influenced by the focused light beam that is used for addressing the qubit. Qubits not identified in the illumination pattern are not addressed, i.e. no focused light beams are generated for these qubits.

Thus, quantum circuits, including digital-analog quantum circuits, may be compiled and/or translated into information representing illumination patterns for addressing individual qubits (associated with ‘digital’ circuits) and for (large) groups of qubits (associated with ‘analog’ circuits). Hence, the addressing scheme may be used both for addressing single qubits at different locations in the qubit register or one or more groups of qubits at different locations in the qubit register.

The computer may configure the micromirrors of the micromirror devices based on the information in the illumination patterns at predetermined time instances, e.g. at a frequency which can be handled by the micromirror devices. For example, in an embodiment, the micromirror devices may be a MEMS based digital micromirror device (DMD) which has switching times of tens of microseconds. For example, at time instance to the first and second micromirror device may be configured based on information associated with a first pair of illumination patterns 1918_{1,2} and at time instance t₁ the first and second micromirror device may be configured based on information associated with a second pair of illumination patterns 1920_{1,2}.

In an embodiment, the addressing information may represent multiple “digital” qubit operations, e.g. single qubit operations. In an embodiment, illumination patterns may represent a plurality of ‘digital’ qubit gate operations and ‘analog’ qubit operations, which can be executed by the optical addressing module at high speed.

A two-qubit operation may be executed by optically addressing one or more neighboring pairs of qubits in the qubit array. For example, illumination patterns 1918_{1,2} may identify one or more pairs of qubits 1918 that are close to each other, wherein the first illumination pattern 1918₁ may be used by the computer to instruct the first micromirror device to spatially modulate the reflected light so that a first qubit 1924₁ of each qubit pair is exposed to a focused laser beam. Similarly, the second illumination pattern may be used by the computer to instruct the second micromirror device to spatially modulate the reflected light so that a second qubit 124₂ of the qubit pair is exposed to a focused laser beam. In an embodiment, these exposures may be part of an execution of a two-qubit logical gate operation.

In a similar way (not shown), the addressing information may identify one or more qubits for performing single qubit operations, such as a NOT gate. A single qubit operation may be executed by optically addressing a qubit identified by an illumination pattern with a focused light pulse (a so-called π-pulse) of a certain amplitude and duration so that when the qubit is in the |1 [symbol] state the laser field will rotate the Bloch vector over an angle of π so that it ends up in the |0 [symbol] state and vice-versa.

In further embodiments, the addressing information may be used to identify qubits that need to be optically addressed for other reasons, e.g. to prepare, e.g. calibrate or initialize qubits in the qubit array. In other embodiments, one or more illumination patterns may be used to identify a large group of qubits to achieve entanglement between the optically addressed group of qubits. Such addressing may be used when using the atomic quantum register for analog quantum computation schemes or for digital-analog quantum computation schemes.

The computer may include an illumination pattern generator 1913, which is configured to convert qubit operations in a quantum circuit to a sequence of illumination patterns representing information identifying which qubits need to be addressed, which is used by the computer to control the micromirror devices to expose predetermined qubits in the qubit array.

To execute the qubit operations of a quantum circuit, the laser system may be controlled to generate a laser beam which is spatially modulated by an SLM, preferably a liquid crystal type SLM, to form a spatially modulated light field. The EOM may be used to temporal modulate the polarization or phase of the spatially modulated light field. The EOM may be controlled by a high frequency control signal so that the polarization or phase may be modulated at high frequencies. In an embodiment, the frequency of the polarization modulation may be between 10 and 100 MHz. This way, the polarization or phase of the spatially modulated light field may be modulated (switches) between (at least) a first polarization and a second polarization or a first phase and a second phase.

Depending on the polarization or phase, the structured light field will be directed by the splitter to the first reflective SLM 1910₁ or to the second reflective SLM 1910₂. Lenses 1911₁₋₃ may be used to focus the spatially modulated light field as a plurality of focused laser beams onto the micromirrors of the reflective SLMs, wherein the illumination pattern determines which qubits are exposed to the focused laser beams. Thus, by switching the polarization of the structured light fields at a high frequency, the qubits in the qubit array may be addressed at a high frequency using different light patterns, e.g. a first light pattern and a second illumination pattern. Thereafter, the reflective SLMs may be configured according to a new set of illumination patterns followed by fast exposure of individual qubits to the new illumination patterns.

Here, optically addressing a qubit or a group of qubits refers to the process of exposing a qubit or a group of qubits with light of a focused laser beam of a certain intensity. Typically, the exposure of a qubit is based on one or more laser pulses of a certain amplitude and duration, typically in the range of nanoseconds. The focused light beam may have an intensity profile such that the light only interacts with the individual qubit or group of qubits without affecting neighboring qubits that are not addressed. When an qubit is optically addressed the light may resonantly interact the qubit. Alternatively, the light may put the addressed qubit in an off-resonant state. Both types of optical addressing can be used for implementing the execution of qubit operations. In some embodiments, individual optical addressing of qubits may be combined with global addressing using e.g. a laser beam that is configured to expose multiple or even all qubits in the qubit array. Alternatively and/or in additional, a microwave field that interacts with the qubits in the qubit array may be used to globally address qubits.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The invention claimed is:

1. A method for solving a computational problem using a data processing system comprising a classical computer connected to neutral atom quantum processor, the method comprising:
encoding at least part of the computational problem in one or more quantum circuits, the one or more quantum circuits comprising gate operations to be executed by the neutral atom quantum processor, the one or more quantum circuit comprising a first quantum circuit comprising at least one quantum feature map configured to map an input variable of a solution of the computational problem to a Hilbert space associated with the neutral atom quantum processor and at least one parameterized ansatz, the first quantum circuit further including digital quantum gate operations and one or more analog quantum gate operations configured to entangle different neutral atoms of the neutral atom quantum processor by evolving a Hamiltonian associated with the neutral atoms in time;
executing the one or more quantum circuits, by the classical computer, the executing including applying optical signals to the neutral atoms of the neutral atom quantum processor to manipulate states of the atoms in accordance with the one or more quantum circuits, the execution providing a final state of the neutral atom quantum processor; and,
determining measurement data associated with the final state of the neutral atoms; and, determining an approximate solution for the computational problem based on the measurement data.

2. The method according to claim 1 wherein the at least one quantum feature map and/or the at least one parameterized ansatz comprises at least one analog quantum gate operation.

3. The method according to claim 1 wherein the one or more quantum circuits comprise a second quantum circuit, the second quantum circuit representing an analytical derivative of the first quantum circuit.

4. The method according to claim 3 wherein the second quantum circuit comprises a differentiated quantum feature map, wherein the differentiated quantum feature map is obtained by analytically differentiating the quantum feature map with respect to the input variable.

5. The method according to claim 3 wherein the second quantum circuit includes a differentiated parameterized ansatz, wherein the differentiated parameterized ansatz is obtained by analytically differentiating the parameterized ansatz with respect to a parameter associated with the parameterized ansatz.

6. The method according to claim 1 wherein the digital gate quantum operations and the analog gate quantum operations are based on a first and second energy levels of the atom.

7. The method according to claim 1 wherein the digital gate quantum operations and the analog gate quantum operations based on a first, second and third energy levels of the atoms, wherein the digital gate quantum operations are based on the first and second energy level and the analog gate quantum operations are based on the second and third energy level.

8. The method according to claim 1 wherein Hamiltonian includes a first part representing an interaction of states of a neutral atom of the neutral atom quantum processor and a laser field and a second part representing an interaction between different neutral atoms if the neutral atoms are in a Rydberg state.

9. The method according to claim 1 wherein the method includes:
controlling position of the atoms of the neutral atom quantum processor such that the atoms form a predetermined spatial arrangement.

10. The method according to claim 9 wherein a distance between neighboring atoms in the predetermined spatial arrangement are selected such that if neighboring atoms are not in a Rydberg state, there is no interaction between neighboring atoms, and if the neighboring atoms are in a Rydberg state, there is an interaction between these neighboring atoms.

11. The method according to claim 9 wherein the one or more quantum circuits include instructions for controlling the position of the atoms during the execution of the one or more quantum circuits and wherein executing the one or more quantum circuits include: changing positions of atoms in the predetermined spatial arrangement to allow an atom to have different neighboring atoms during the execution of the one or more quantum circuits.

12. The method according to claim 1 wherein executing the one or more quantum circuits includes translating the one or more quantum circuits into optical signals for controlling states of the neural atoms in accordance with the gate operations of the one or more quantum circuits and for readout of a final state of the neutral atoms.

13. The method according to claim 1 wherein translating the one or more quantum circuits includes:
translating a first digital gate operation and a second digital gate operation into control information for exposing a first atom with a first optical pulse and a second atom with a second optical pulse, wherein the first and second optical pulses have a predetermined amplitude, frequency and duration to control the states of the first and second atom in accordance with the first and second digital gate operations respectively; and,
using the control information to control one or more light sources and one or more optical deflectors or one or more spatial light modulators to locally expose the first and second atom with the first and second optical pulse.

14. The method according to claim 1 wherein executing the one or more quantum circuits includes optically addressing one or more individual neutral atoms in accordance with one or more digital quantum gate operations.

15. The method according to claim 1 wherein executing the one or more quantum circuits includes optically addressing the neutral atoms in accordance with the one or more analog quantum gate operations.

16. The method according to claim 14 wherein one or more micromirrors are used to optically address the individual neutral atoms associated with the one or more digital quantum gate operations and the neutral atoms associated with the one or more analog quantum gate operations.

17. A system for solving a computational problem comprising a classical computer connected to neutral atom quantum processor, wherein the system is configured to perform steps of:
encoding at least part of the computational problem in one or more quantum circuits, the one or more quantum circuits comprising gate operations to be executed by the neutral atom quantum processor, the one or more quantum circuit comprising a first quantum circuit comprising at least one feature map configured to map an input variable of a solution of the computational problem to a Hilbert space associated with the neutral atom quantum processor and at least one parameterized ansatz, the first quantum circuit further including digital quantum gate operations and one or more analog quantum gate operations configured to entangle different neutral atoms of the neutral atom quantum processor by evolving a Hamiltonian associated with the neutral atoms in time;
executing the one or more quantum circuits, by the classical computer, the executing including applying optical signals to the neutral atoms of the neutral atom quantum processor to manipulate states of the atoms in accordance with the one or more quantum circuits, the execution providing a final state of the neutral atom quantum processor; and,
determining measurement data associated with the final state of the neutral atoms; and,
determining an approximate solution for the computational problem based on the measurement data.

18. (canceled)

19. A tangible computer readable storage medium having a computer program or suite of computer programs comprising at least one software code portion, the at least one software code portion, when run on a classical computer system wherein the classical computer system is part of a data processing system comprising the classical computer system connected to a neutral atom quantum processor, being configured for executing a method comprising:
encoding at least part of a computational problem in one or more quantum circuits, the one or more quantum circuits comprising gate operations to be executed by the neutral atom quantum processor, the one or more quantum circuit comprising a first quantum circuit comprising at least one feature map configured to map an input variable of a solution of the computational problem to a Hilbert space associated with the neutral atom quantum processor and at least one parameterized ansatz, the first quantum circuit further including digital quantum gate operations and one or more analog quantum gate operations configured to entangle different neutral atoms of the neutral atom quantum processor by evolving a Hamiltonian associated with the neutral atoms in time;
executing the one or more quantum circuits, by the classical computer system, the executing including applying optical signals to the neutral atoms of the neutral atom quantum processor to manipulate states of the atoms in accordance with the one or more quantum circuits, the execution providing a final state of the neutral atom quantum processor; and,
determining measurement data associated with the final state of the neutral atoms; and, determining an approximate solution for the computational problem based on the measurement data.

20. The method according to claim 6 wherein the first energy level is associated with a ground state or a hyper-fine energy level of the atoms and the second energy level is associated with a Rydberg state of the atoms.

21. The method according to claim 7 wherein the first energy level is associated with a ground state of the atoms, a second energy level is associated with a hyper-fine energy level of the atoms and a third energy level is associated with a Rydberg state of the atoms.
